(19) United States
(12) Patent Application Publication
(10) Pub. No.: US 2022/0256518 A1
(43) Pub. Date: Aug. 11, 2022

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Yanzhao HOU, Beijing (CN); Lei GAO, Beijing (CN); Min ZHU, Beijing (CN); Bing WANG, Beijing (CN); Xiaofeng TAO, Beijing (CN); Tao CUI, Beijing (CN)

(73) Assignee: Sony Group Corporation, Tokyo (JP)

(21) Appl. No.: 17/611,920

(22) PCT Filed: Jun. 17, 2020
(86) PCT No.: PCT/CN2020/096520

§ 371 Date: Nov. 17, 2021

(30) Foreign Application Priority Data
Jun. 24, 2019 (JP) 201910551238.6

(51) Int. Cl. H04W 72/04; H04W 72/10; H04L 1/18

(52) U.S. Cl. CPC H04W 72/044; H04L 1/1812; H04W 72/10; H04W 72/0406

(57) ABSTRACT

Provided are an electronic device and method for wireless communication, and a computer-readable storage medium. The electronic device for wireless communication comprises: a processing circuit configured to: perform data transmission by means of a time-frequency repetition pattern (TFRP) time-frequency resource configured or pre-configured by a base station that provides a service for an electronic device, wherein the TFRP time-frequency resource comprises, within one cycle, a plurality of time-frequency resource blocks, and the plurality of time-frequency resource blocks comprise a special resource block, and further comprise, in the case where same meets a predetermined condition, a shared resource block; the special resource block is used for transmitting data specific to the special resource block, and the shared resource block is shared by all the data to be transmitted for transmission; and different shared resource blocks having the same frequency-domain range are continuous in terms of the time domain.

### FIELD OF THE INVENTION

This application claims the priority of Chinese Patent Application No. 201910551238.6, entitled “ELECTRONIC DEVICE AND METHOD FOR WIRELESS COMMUNICATION, AND COMPUTER-READABLE STORAGE MEDIUM”, filed with the Chinese Patent Office on Jun. 24, 2019, the entire contents of which are incorporated herein by reference.

### TECHNICAL FIELD

The present disclosure relates to the technical field of wireless communications, particularly to the design of Time-Frequency Repetition Pattern TFRP time-frequency resources and a data transmission mechanism in this pattern, and more particularly, to an electronic apparatus and method for wireless communications, and a computer-readable storage medium.

### BACKGROUND ART

V2X (Vehicle-to-Outside Information Exchange, Vehicle to Everything) scenarios, D2D (Device-to-Device) scenarios, MTC (Mobile Cloud Test Center) scenarios, and drone scenarios are currently popular wireless communication application scenarios. Considering the development trend of next-generation mobile communications, TS 36.213 respectively defines in modes 1 and 2 in NR (New Radio Access Technology in 3GPP) V2X a determination method of time-frequency resources for a user to transmit a PSCCH (Physical Sidelink Control Channel) and a corresponding PSSCH (Physical Sidelink Shared Channel) and a UE (User Equipment) process that receives a PSCCH, and meanwhile defines information domain and configuration manner of SCI (Sidelink Control Information). In addition, TS 38.885 defines a SL (Sidelink) resource allocation method and a process of HARQ (Hybrid Automatic Repeat Request) feedback in NR V2X, wherein a transmission mechanism of Time-Frequency Repetition Pattern TFRP is defined in NR V2X resource allocation submode 2c.

### SUMMARY OF THE INVENTION

A brief summary of the present invention is given below, to provide a basic understanding of some aspects of the present invention. It should be understood that the following summary is not an exhaustive summary of the present invention. It does not intend to determine a key or important part of the present invention, nor does it intend to limit the scope of the present invention. Its object is only to present some concepts in a simplified form, which serves as a preamble of a more detailed description to be discussed later.

According to one aspect of the present disclosure, there is provided an electronic apparatus for wireless communications, comprising: processing circuitry configured to: perform data transmission utilizing Time-Frequency Repetition Pattern TFRP time-frequency resources configured by a base station serving the electronic apparatus or pre-configured, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

According to one aspect of the present disclosure, there is provided a method for wireless communications, comprising: performing data transmission utilizing Time-Frequency Repetition Pattern TFRP time-frequency resources configured by a base station serving the electronic apparatus or pre-configured, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

According to another aspect of the present disclosure, there is provided an electronic apparatus for wireless communications, comprising: processing circuitry configured to: configure, for user equipment within coverage of the electronic apparatus, Time-Frequency Repetition Pattern TFRP time-frequency resources to perform data transmission, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

According to another aspect of the present disclosure, there is provided a method for wireless communications, comprising: configuring, for user equipment within coverage of a base station, Time-Frequency Repetition Pattern TFRP time-frequency resources to perform data transmission, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

According to other aspects of the present invention, there are further provided a computer program code and a computer program product for implementing the above-mentioned methods for wireless communications, as well as a computer-readable storage medium on which the computer program code for implementing the above-mentioned methods for wireless communications is recorded.

These and other advantages of the present invention will be more apparent through the following detailed description of preferred embodiments of the present invention in conjunction with the accompanying drawings.

### BRIEF DESCRIPTION OF THE DRAWINGS

In order to further set forth the above and other advantages and features of the present invention, specific embodiments of the present invention will be further described in detail below in conjunction with the accompanying drawings. The accompanying drawings together with the following detailed description are included in this specification and form a part of this specification. Elements with identical functions and structures are denoted by identical reference numerals. It should be understood that, these figures only describe typical examples of the present invention, and should not be regarded as limitations to the scope of the present invention. In the accompanying drawings:

FIG. 1 shows a block diagram of functional modules of an electronic apparatus for wireless communications according to an embodiment of the present disclosure;

FIG. 2 shows a schematic diagram of TFRP time-frequency resources according to an embodiment of the present disclosure;

FIGS. 3(a) and 3(b) show schematic diagrams of dividing a time-frequency resource block into mini-slot based resource blocks in time according to an embodiment of the present disclosure;

FIG. 4 shows information flow of configuring TFRP time-frequency resources by a base station for a UE;

FIGS. 5(a) and 5(b) show schematic diagrams of dividing a time-frequency resource block according to division granularity according to an embodiment of the present disclosure;

FIG. 6 shows information flow of updating the configuration of the UE's time-frequency resource blocks by the base station periodically;

FIG. 7 shows information flow of updating the configuration of the UE's time-frequency resource blocks by the base station based on event triggering;

FIG. 8 shows a schematic diagram of data arriving only after a dedicated resource block starts, resulting in transmission latency;

FIG. 9 shows information flow about preemption among the base station, an electronic apparatus as a sending party, and a neighboring electronic apparatus within coverage of the base station;

FIG. 10 shows information flow about borrowing among the base station, the electronic apparatus as the sending party, and an electronic apparatus as a receiving party;

FIG. 11 shows a schematic diagram of a pre-configured TFRP pool according to an embodiment of the present disclosure;

FIG. 12 shows a schematic diagram of performing data transmission using shared resource blocks according to an embodiment of the present disclosure;

FIG. 13 shows information flow of performing data transmission between a UE as a sending party and a UE as a receiving party out of coverage of the base station in a submode 2c of V2X;

FIG. 14 shows a schematic diagram of resource collisions;

FIG. 15 shows exemplary information flow of performing HARQ feedback between the UE as the sending party and the UE as the receiving party in the submode 2c of V2X;

FIG. 16 shows another exemplary information flow of performing HARQ feedback between the UE as the sending party and the UE as the receiving party in the submode 2c of V2X;

FIG. 17 shows a block diagram of functional modules of an electronic apparatus according to another embodiment of the present disclosure;

FIG. 18 shows a flowchart of a method for wireless communications according to an embodiment of the present application;

FIG. 19 shows a flowchart of a method for wireless communications according to another embodiment of the present application;

FIG. 20 is a block diagram showing a first example of a schematic configuration of an eNB or gNB to which the technology of the present disclosure can be applied;

FIG. 21 is a block diagram showing a second example of a schematic configuration of an eNB or gNB to which the technology of the present disclosure can be applied;

FIG. 22 is a block diagram showing an example of a schematic configuration of a smart phone to which the technology of the present disclosure can be applied;

FIG. 23 is a block diagram showing an example of a schematic configuration of automobile navigation equipment to which the technology of the present disclosure can be applied;

FIG. 24 is a block diagram of an exemplary structure of a universal personal computer in which the methods and/or apparatuses and/or systems according to the embodiments of the present invention can be implemented.

### DETAILED DESCRIPTION OF THE EMBODIMENTS

Hereinafter, exemplary embodiments of the present disclosure will be described in conjunction with the accompanying drawings. For the sake of clarity and conciseness, the description does not describe all features of actual embodiments. However, it should be understood that in developing any such actual embodiment, many decisions specific to the embodiments must be made, so as to achieve specific objects of a developer; for example, those limitation conditions related to systems and services are satisfied, and these limitation conditions possibly will vary as embodiments are different. In addition, it should also be appreciated that, although developing work may be very complicated and time-consuming, such developing work is only routine tasks for those skilled in the art benefiting from the present disclosure.

It should also be noted herein that, to avoid the present invention from being obscured due to unnecessary details, only those apparatus structures and/or processing steps closely related to the solution according to the present invention are shown in the accompanying drawings, while omitting other details not closely related to the present invention.

### First Embodiment

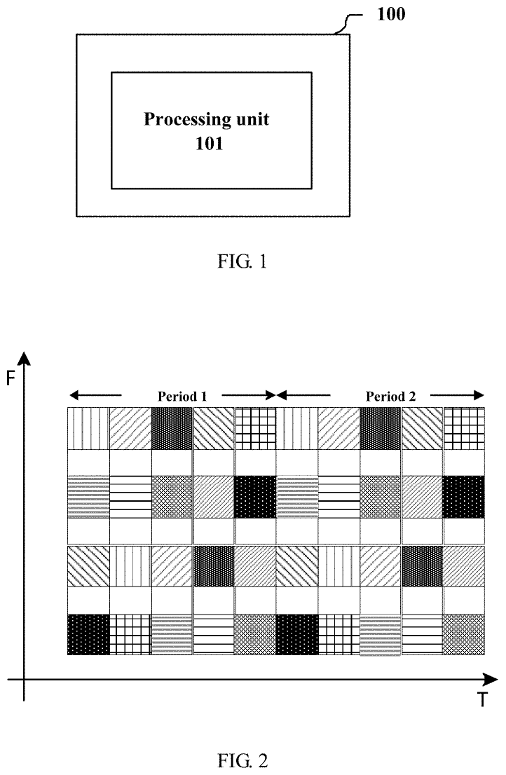

FIG. 1 shows a block diagram of functional modules of an electronic apparatus 100 for wireless communications according to an embodiment of the present disclosure. As shown in FIG. 1, the electronic apparatus 100 comprises: a processing unit 101 configured to perform data transmission utilizing Time-Frequency Repetition Pattern TFRP time-frequency resources configured by a base station serving the electronic apparatus or pre-configured, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

Wherein, the processing unit 101 may be implemented by one or more processing circuitries which may be implemented as, for example, a chip.

The electronic apparatus 100 may be arranged on user equipment (UE) side or communicably connected to a UE, for example. It should also be noted herein that, the electronic apparatus 100 may be implemented at chip level or at device level. For example, the electronic apparatus 100 may work as user equipment itself, and may also include external devices such as a memory, a transceiver (not shown in the figure) and the like. The memory may be used to store programs and related data information that the user equipment needs to execute in order to implement various functions. The transceiver may include one or more communication interfaces to support communication with different devices (e.g., a base station, other user equipment, etc.), and the implementation form of the transceiver is not specifically limited here.

FIG. 2 shows a schematic diagram of TFRP time-frequency resources according to an embodiment of the present disclosure. The TFRP time-frequency resources are repeated periodically. In FIG. 2, for the sake of conciseness, only TFRP time-frequency resources within two periods (e.g., period 1 and period 2) are shown, wherein the abscissa T represents time, and the ordinate F represents frequency. TFRP time-frequency resources similar to those shown in FIG. 2 are sometimes also referred to as a TFRP pool hereinafter.

The TFRP time-frequency resource comprises a plurality of time-frequency resource blocks within one period. The white time-frequency resource blocks that are not filled with any pattern in FIG. 2 are shared resource blocks, and the remaining time-frequency resource blocks that are filled with patterns are dedicated resource blocks. Within one period of the TFRP time-frequency resources, a TB (Transport Block) needs to be repeatedly transmitted repK times, where repK is determined by the configuration of TFRP. The dedicated resource blocks specify the time domain and frequency domain resources used for initial transmission of a TB and several retransmissions of the TB. To simplify the description, it is assumed in FIG. 2 that within one period of the TFRP time-frequency resources, dedicated resource blocks with the same pattern repeatedly appear twice. Accordingly, repK is 2. Taking the TFRP time-frequency resources within the period 1 in FIG. 2 as an example, two dedicated resource blocks with the same pattern may be used for one initial transmission and one retransmission of a TB, that is, once the dedicated resource block for the initial transmission of the TB is determined, the dedicated resource block used for the retransmission of the TB is then also determined. The shared resource blocks are shared by all TBs to be transmitted. If both the initial transmission of the TB and the retransmission of the TB use shared resource blocks, there is no relationship between the two shared resource blocks. Further, as shown in FIG. 2, different shared resource blocks with the same frequency domain range are consecutive in time domain.

In a case where the electronic apparatus is within coverage of the base station, the time-frequency resource blocks are configured for the electronic apparatus by the base station. In a case where there are relatively more electronic apparatuses within coverage of the base station so that the time-frequency resource is in shortage, the TFRP time-frequency resource does not include shared resource blocks, and then all data is transmitted by dedicated resource blocks.

One example of the predetermined condition is that the time-frequency resource within coverage of the base station is relatively abundant. In a case where the predetermined condition is satisfied, the TFRP time-frequency resource may include shared resource blocks, and accordingly the data may be transmitted by dedicated resource blocks and/or shared resource blocks. In a case where the electronic apparatus is out of coverage of the base station, the electronic apparatus performs data transmission based on a pre-configured TFRP pool including time-frequency resource blocks. Another example of the predetermined condition is that the electronic apparatus is out of coverage of the base station. In a case where the predetermined condition is satisfied, the pre-configured TFRP time-frequency resource of the electronic apparatus includes shared resource blocks, and accordingly the data is transmitted by the dedicated resource blocks and/or shared resource blocks.

In addition, it should be noted that the above-mentioned electronic apparatus 100 may be used for wireless communications in V2X scenarios, D2D scenarios, MTC scenarios, drone scenarios, etc. However, for the sake of convenience and conciseness, the following description is made by taking only the V2X scenarios as an example.

Preferably, a frequency domain bandwidth of the shared resource block is equal to or less than that of the dedicated resource block. In FIG. 2, it is shown that the frequency domain bandwidth of the shared resource block is less than that of the dedicated resource block.

Some advanced application scenarios in NR V2X require low latency (as low as 3 ms end-to-end latency) and high reliability (up to 99.999%). In order to satisfy the above-mentioned requirements, the above-mentioned time-frequency resource blocks may be divided in time.

Preferably, each time-frequency resource block may be divided in time into at least two mini-slot based resource blocks. That is, the dedicated resource block and the shared resource block may be divided in time into at least mini-slot based resource blocks.

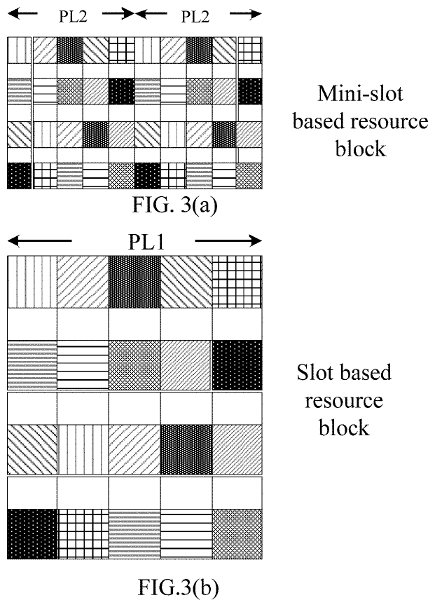

FIGS. 3(a) and 3(b) show schematic diagrams of dividing a time-frequency resource block into mini-slot based resource blocks in time according to an embodiment of the present disclosure. In the following description, a dedicated resource block and a shared resource block before being divided may be referred to as slot based resource blocks in order to distinguish them from mini-slot based resource blocks. In FIG. 3(a), a plurality of slot based resource blocks included in a TFRP period length PL1 are shown. In FIG. 3(b), for simplicity, each dedicated resource block and shared resource block are divided in time into two mini-slot based resource blocks. A time length of the mini-slot based resource block is shorter than that of the slot based resource block (in the examples of FIGS. 3 (a) and 3 (b), the time length of the mini-slot based resource block is a half of that of the slot based resource block), so latency may be reduced through faster retransmissions; further, a TFRP period length PL2 of the mini-slot based resource block is a half (PL1/2) of the TFRP period length PL1 of the slot based resource block, that is, within one TRRP period (with a period length being PL1) of the TFRP time-frequency resources including the slot based resource blocks, the TFRP time-frequency resources including the mini-slot based resource blocks may use two TRRP periods (with a period length being PL2=PL1/2) to perform data transmission, and thus the TFRP time-frequency resources including the mini-slot based resource blocks may ensure the reliability of the data by increasing the number of retransmissions.

After the electronic apparatus enters coverage of the base station (a cell covered by the base station), the TFRP time-frequency resource pre-configured for the electronic apparatus is prohibited from being used within the cell. As shown above, in the case where the electronic apparatus is within coverage of the base station, the time-frequency resource blocks are configured for the electronic apparatus by the base station. The configuration of the TFRP time-frequency resources and the data transmission mechanism in the case where the electronic apparatus is within coverage of the base station will be described below.

A configuration index of the TFRP time-frequency resource is cell-based, that is, how the TFRP time-frequency resource is configured is determined by a cell. TFRP time-frequency resource configurations between different cells may be either the same or different. Moreover, a TFRP time-frequency resource configuration of the same cell will also be updated at any time along with a usage condition of the time-frequency resource of the cell.

Preferably, the processing unit 101 is configured to report information to the base station serving it, so that the base station configures the time-frequency resource blocks for the electronic apparatus based on the reported information, and the reported information at least includes information EquipmentIdentifier indicating whether the electronic apparatus supports mini-slot transmission, wherein in the mini-slot transmission, the time-frequency resource block is divided in time into at least two mini-slot based resource blocks.

As an example, the reported information may also include: channel state information CSI, channel busy rate CBR, reference signal (DMRS/SRS), user's measurement results (SL RSRP and SL RSSI), and location information LocationInfor.

Preferably, the processing unit 101 is configured to receive, from the base station, radio resource control RRC signaling including information concerning the time-frequency resource block, wherein the RRC signaling is generated based on the information reported by the electronic apparatus, and at least includes a frequency domain bandwidth BandWidthShared of the shared resource block and division granularity PeriodScaler of the time-frequency resource block.

As an example, the RRC signaling may also include a period length PeriodLength of the TFRP time-frequency resource, the number NumberOfPeriod of periods of the TFRP time-frequency resource, the number NumberOfSymbolOfRep of symbols occupied by each time-frequency resource block, the number NumberOfRepetition of data retransmissions within one period, a start time StartTime of each time-frequency resource block, and a bandwidth BandWidthDedicate of the dedicated resource block.

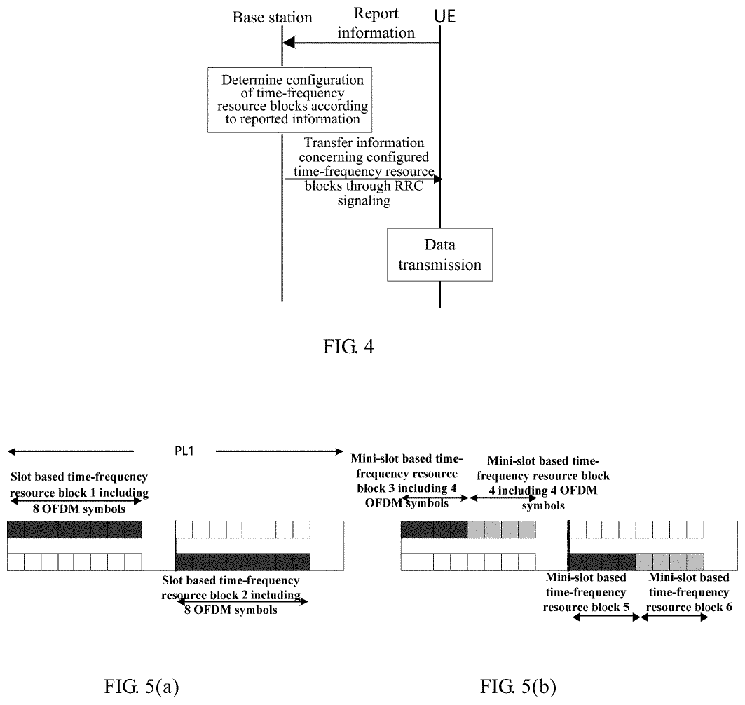

For ease of understanding, FIG. 4 shows information flow of configuring TFRP time-frequency resources by a base station (e.g., gNB) for a UE. As shown in FIG. 4, first, the UE reports information to the base station. Then, the base station determines a time-frequency resource block configuration according to the reported information, and transfers information concerning the configured time-frequency resource blocks to the UE through RRC signaling. The UE performs data transmission based on the configured time-frequency resource blocks. It should be noted that, the information flow in FIG. 4 is only schematic and does not constitute a limitation to the present disclosure.

As an example, the RRC signaling is divided into two modes, i.e., Mode 1 and Mode 1. The Mode 1 is used to configure an electronic apparatus that supports mini-slot transmission. As described above, whether an electronic apparatus supports mini-slot transmission is indicated by the EquipmentIdentifier domain in the information reported by it. If the base station determines that an electronic apparatus supports mini-slot transmission according to the information reported by the electronic apparatus, the RRC Mode 1 is used to configure TFRP time-frequency resources for the electronic apparatus.

When the information reported by the electronic apparatus indicates that the electronic apparatus does not support mini-slot transmission, the base station uses the RRC Mode 2 to configure TFRP time-frequency resources for the electronic apparatus.

The difference between the RRC Mode 1 and the RRC Mode 2 lies in granularity division domain PeriodScaler.

Preferably, in a case where the electronic apparatus supports mini-slot transmission, the division granularity PeriodScaler indicates the number of the mini-slot based resource blocks into which the time-frequency resource block is divided. In a case where the electronic apparatus does not support the mini-slot transmission, a value of the division granularity defaults and has no meaning.

As an example, in the RRC Mode 1, the PeriodScaler domain may be a set of several integers, e.g., {2, 3, 4 . . . }, each integer is used to indicate the number of the mini-slot based resource blocks into which the time-frequency resource block is divided; and in the RRC Mode 2, the value of the PeriodScaler field defaults and has no meaning.

After receiving the RRC signaling, the electronic apparatus may further divide each time-frequency resource block according to the PeriodScaler domain.

FIGS. 5(a) and 5(b) show schematic diagrams of dividing a time-frequency resource block according to division granularity according to an embodiment of the present disclosure. In FIG. 5(a), it is assumed that within the period length PL1 of TFRP, one TB is to be transmitted twice. Each slot based time-frequency resource block contains 8 OFDM symbols. For example, a slot based time-frequency resource block 1 includes 8 OFDM symbols, and a slot based time-frequency resource block 2 used to transfer the same TB as the slot based time-frequency resource block 1 includes 8 OFDM symbols. If the PeriodScaler domain is {4}, the electronic apparatus may further divide each slot based time-frequency resource block containing 8 OFDM symbols into 2 mini-slot based resource blocks, wherein each mini-slot based resource block contains 4 OFDM symbols. For example, in FIG. 5(b), the slot based time-frequency resource block 1 is divided into a mini-slot based time-frequency resource block 3 including 4 OFDM symbols and a mini-slot based resource block including 4 OFDM symbols. Similarly, the slot based time-frequency resource block 2 may be divided into a mini-slot based time-frequency resource block 5 including 4 OFDM symbols and a mini-slot based time-frequency resource block 6 including 4 OFDM symbols. It should be noted that although in FIG. 5(b), the mini-slot based time-frequency resource block 3 and the mini-slot based time-frequency resource block 5 are represented in the same color and the mini-slot based time-frequency resource block 4 and the mini-slot based time-frequency resource block 6 are represented in the same color, it should not be understood that the mini-slot based time-frequency resource block 3 and the mini-slot based time-frequency resource block 5 must be used to transmit the same TB, and it should not be understood that the mini-slot based time-frequency resource block 4 and the mini-slot based time-frequency resource block 6 must be used to transmit the same TB.

As described with reference to FIGS. 3(a) and 3(b), a time length of the mini-slot based resource block is shorter than that of the slot based resource block, so latency may be reduced through faster retransmissions. Further, as shown in FIG. 5(b), within PL1, the TFRP time-frequency resources including the mini-slot based resource blocks may transfer the TB up to four times, so the TFRP time-frequency resources including the mini-slot based resource blocks may ensure the reliability of the data by increasing the number of retransmissions.

Preferably, the configuration of the time-frequency resource blocks is dynamically updated by the base station periodically and/or based on event triggering. That is, the base station may dynamically update the configuration of the time-frequency resource blocks. This updating mechanism may be performed periodically, for example, according to the periodic reporting by the electronic apparatus, and/or may be event-triggered (for example, the base station instructs the updating of the time-frequency resource blocks of the electronic apparatus through DCI (Downlink Control Information) according to the reporting by the electronic apparatus).

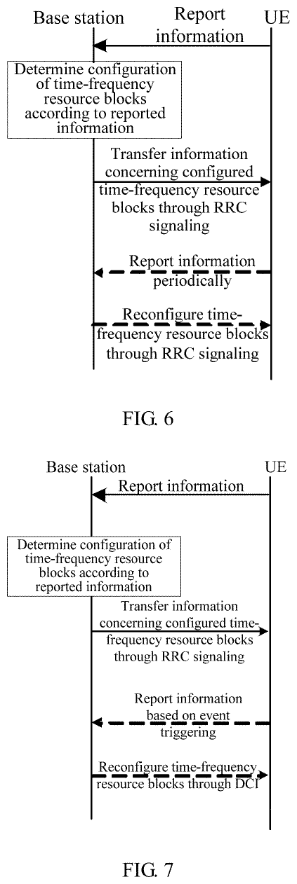

For ease of understanding, FIG. 6 shows information flow of updating the configuration of the UE's time-frequency resource blocks by the base station periodically. The “the UE reports information to the base station” and “the base station transfers information concerning the configured time-frequency resource blocks to the UE through RRC signaling” in FIG. 6 are the same as those in FIG. 4, and will not be repeatedly described here. As indicated by the two dashed arrows in FIG. 6, the UE reports information to the base station periodically, and then the base station reconfigures the time-frequency resource blocks through RRC signaling. It should be noted that, the information flow in FIG. 6 is only schematic and does not constitute a limitation to the present disclosure.

FIG. 7 shows information flow of updating the configuration of the UE's time-frequency resource blocks by the base station based on event triggering. The “the UE reports information to the base station” and “the base station transfers information concerning the configured time-frequency resource blocks to the UE through RRC signaling” in FIG. 7 are the same as those in FIG. 4, and will not be repeatedly described here. As indicated by the two dashed arrows in FIG. 7, the UE reports information to the base station based on event triggering, and then the base station reconfigures the time-frequency resource blocks of the UE through DCI. It should be noted that, the information flow in FIG. 7 is only schematic and does not constitute a limitation to the present disclosure.

It should be noted that, the configuration of the time-frequency resource blocks is dynamically updated only when the base station has available time-frequency resources.

In a case where the electronic apparatus is configured with a single set of time-frequency resource blocks, the processing unit 101 does not need to perform a sensing process.

Preferably, in a case where the electronic apparatus is configured with multiple groups of time-frequency resource blocks, the processing unit 101 is configured to select a set of time-frequency resource blocks for data transmission based on at least one of data type, quality of service, communication manner and location information. That is, in the case where the electronic apparatus is configured with multiple sets of time-frequency resource blocks, the processing unit 101 needs to select a set of appropriate time-frequency resource blocks to perform data transmission.

When the electronic apparatus uses the configured time-frequency resource blocks to perform data transmission, the processing unit 101 is configured to send SCI to an electronic apparatus as a receiving party, wherein the SCI includes the repeat transmission number repK within one period of the TFRP time-frequency resources, HARQ procedure ID (which indicates a HARQ procedure, for the electronic apparatus as the receiving party to perform soft combining), redundancy version number RV, information TFRP configuration concerning the time-frequency resource blocks as used, and data priority PacketPrio.

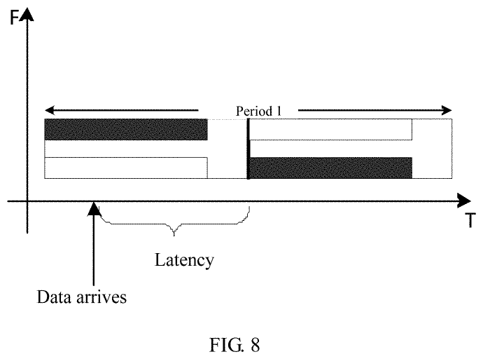

As once mentioned above, in a case where there are relatively more electronic apparatuses within coverage of the base station so that the time-frequency resource is in shortage, the TFRP time-frequency resource does not include shared resource blocks. A data transmission mechanism in a case where the TFRP time-frequency resource does not include shared resource blocks will be described hereinafter. Since the electronic apparatus cannot predict when the data will arrive, not all dedicated resource blocks configured by the base station for the electronic apparatus possibly can be used to perform sending of data. FIG. 8 shows a schematic diagram of data arriving only after a dedicated resource block starts, resulting in transmission latency. As shown in FIG. 8, assuming that two black dedicated resource blocks are designated for initial transmission and retransmission of data and that the data arrives only after the first black dedicated resource block starts, at this time the electronic apparatus cannot use the first black dedicated resource block to perform transmission of the data, and the data can be sent only after the second black dedicated resource block starts. As such, latency will be caused. Moreover, since the electronic apparatus can only send the data once within the period 1 as shown in FIG. 8, the reliability of the data will also decrease. In order to solve the above-mentioned problems, the present application proposes a TFRP preemption mechanism to ensure that a high-priority user obtains a service preferentially.

Preferably, the processing unit 101 is configured to: receive, from the base station, information concerning configurations of the dedicated resource blocks of other electronic apparatuses within the coverage of the base station; compare a priority of a service of the electronic apparatus with priorities of services of the other electronic apparatuses; preempt the dedicated resource blocks of the electronic apparatus with a lower priority than the priority of the service of the electronic apparatus, for data transmission; and send resource preemption information PreemptionInfor to the preempted electronic apparatuses.

Preferably, the processing unit 101 is configured to: send the resource preemption information PreemptionInfor through Sidelink Control Information SCI, wherein the SCI comprises data priority PacketPrio, occupied resource duration TimeDuration, and information TFRP configuration indicating occupied dedicated resource blocks.

Preferably, if the preempted electronic apparatus is sending data through the preempted dedicated resource blocks when it is preempted, the data transmission of the preempted electronic apparatus breaks off, and the preempted electronic apparatus reports information concerning resources being preempted to the base station and requests the base station to reconfigure time-frequency resource blocks. If the preempted dedicated resource blocks are in an idle state when the preempted electronic apparatus is preempted, the information concerning resources being preempted is not reported to the base station in a case where the occupied resource duration is lower than a predetermined threshold, and the information concerning resources being preempted is reported to the base station in a case where the occupied resource duration is higher than the predetermined threshold.

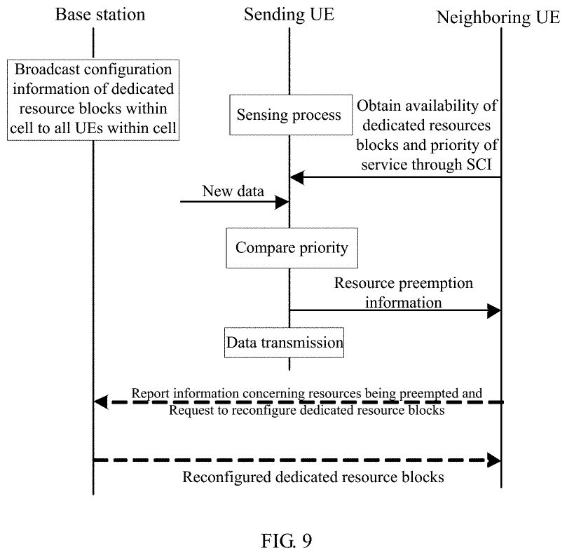

FIG. 9 shows information flow about preemption among the base station, an electronic apparatus (hereinafter referred to as a sending UE) as a sending party, and a neighboring electronic apparatus within coverage (within the cell) of the base station. First, upon completion of configuration of dedicated resource blocks by the base station for all UEs within the cell, configuration information of the dedicated resource blocks within the cell is broadcasted to all UEs within the cell; the sending UE uses a sensing process to obtain the availability of the dedicated resources used by the neighboring UE within the cell and the priority of the service of sending through SCI; when new data arrives and the dedicated resource blocks configured by the base station for the sending UE cannot satisfy transmission of the new data, the sending UE compares a priority of its own service with a priority of the neighboring UE; if the sending UE finds that the priority of its own service is higher than priority of the service of the neighboring UE, the sending UE will preempt dedicated resource blocks suitable for its own service sending to perform data transmission, and when preempting the dedicated resource blocks of the neighboring UEs, the sending UE will send a resource preemption message to inform the preempted UE; if the preempted UE is sending data through the preempted dedicated resource blocks when it is preempted, the preempted UE reports information concerning resources being preempted to the base station and requests the base station to reconfigure dedicated resource blocks, and the base station reconfigures dedicated resource blocks for the preempted UE based on the reported information. If the preempted dedicated resource blocks are in an idle state when the preempted UE is preempted, the information concerning resources being preempted is reported to the base station in a case where an occupied resource duration is higher than a predetermined threshold. It should be noted that, the information flow in FIG. 9 is only schematic and does not constitute a limitation to the present disclosure.

As can be known from the above description, even if it is possible that the dedicated resource blocks configured by the base station for the electronic apparatus cannot be all used to perform sending of data, the electronic apparatus may still preempt the dedicated resource blocks of other electronic apparatuses through a preemption mechanism, thereby ensuring that the data is sent according to a predetermined transmission number within one period of TFRP, thereby ensuring fast and reliable transmission of the data.

Furthermore, the present application also proposes a TFRP borrowing mechanism to ensure that a high-priority user obtains a service preferentially.

Preferably, the processing unit 101 is configured to: receive, from the base station, information concerning configurations of the dedicated resource blocks of other electronic apparatuses within the coverage of the base station; send a resource borrowing application message to electronic apparatuses as receiving parties or electronic apparatuses for sending with lower priorities than the priority of the service of the electronic apparatus among the other electronic apparatuses; if feedback information of consenting to borrowing is received from an electronic apparatus to which borrowing is applied for, select, from the dedicated resource blocks of the electronic apparatus to which borrowing is applied for, dedicated resource blocks to perform data transmission, and if no feedback information is received from the electronic apparatuses to which borrowing is applied for, apply to the base station for the time-frequency resource blocks for data transmission.

Preferably, the processing unit 101 is configured to send the resource borrowing application message through SCI, wherein the SCI comprises data packet sending duration TimeDuration, data packet size PacketSize, and data priority PacketPrio.

Preferably, the electronic apparatus to which borrowing is applied for, when receiving the resource borrowing application message, replies the feedback information of consenting to borrowing to the electronic apparatus if dedicated resource blocks thereof are in an idle state, and does not make a response if dedicated resource blocks thereof are not in an idle state.

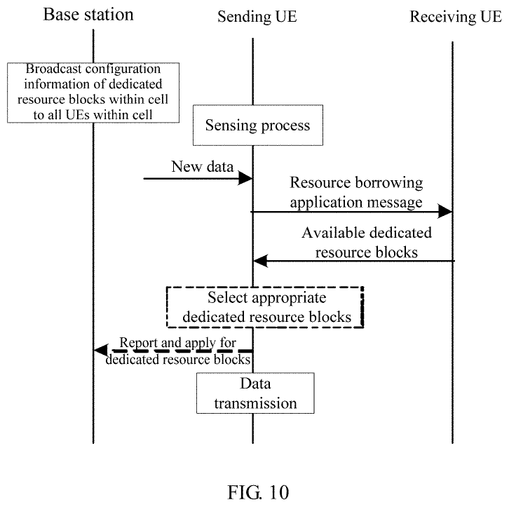

FIG. 10 shows information flow about borrowing among the base station, the electronic apparatus (hereinafter referred to as the sending UE) as the sending party, and an electronic apparatus as a receiving party. First, upon completion of configuration of dedicated resource blocks by the base station for all UEs within the cell, configuration information of the dedicated resource blocks within the cell is broadcasted to all UEs within the cell; the sending UE continuously performs a sensing process; when new data arrives and the dedicated resource blocks configured by the base station for the sending UE cannot satisfy transmission of the new data, the sending UE sends a resource borrowing application message to the receiving UE; the receiving UE, after receiving the resource borrowing application message, feeds back information to the sending UE to indicate available dedicated resource blocks if dedicated resource blocks thereof are in an idle state; otherwise, no response is made; after the sending UE receives the feedback information from the receiving UE, it can select appropriate dedicated resource blocks to perform data transmission based on, for example, the QoS of the data. If the feedback information is not received, the sending UE reports to the base station and applies for dedicated resource blocks for sending data. It should be noted that, the information flow in FIG. 10 is only schematic and does not constitute a limitation to the present disclosure. In addition, the information flow about borrowing among the base station, the sending UE, and other UEs for sending with lower priorities than the priority of the service of the sending UE is similar to the information flow as shown in FIG. 10, and will not be repeated here.

As can be known from the above description, the electronic apparatus may borrow dedicated resource blocks of electronic apparatuses as receiving parties or electronic apparatuses for sending with lower priorities than the priority of the service of the electronic apparatus by borrowing mechanism, thereby ensuring that the data is sent according to a predetermined transmission number within one period of TFRP, thereby ensuring fast and reliable transmission of the data.

As once mentioned above, in a case where the electronic apparatus is within coverage of the base station, while satisfying the predetermined condition (for example, the time-frequency resource within coverage of the base station is relatively abundant), the TFRP time-frequency resource may include shared resource blocks. Data packet sizes of different services are different, and even for the same service, data packet sizes at different times will also change. Thus preferably, while satisfying the predetermined condition, the TFRP time-frequency resource includes shared resource blocks, and the processing unit 101 is configured to simultaneously use the dedicated resource blocks and shared resource blocks adjacent to the dedicated resource blocks in frequency domain to jointly transmit data, so as to utilize the adjacent shared resource blocks to extend the dedicated resource blocks in frequency domain, for adaptation to different data packet sizes. In addition, the above-described data transmission mechanism in a case where the electronic apparatus is within coverage of the base station and the TFRP time-frequency resource does not include shared resource blocks may also be applied to a case where the electronic apparatus is within the coverage of the base station and the TFRP time-frequency resource includes shared resource blocks, which will not be repeated here.

The data transmission mechanism in a case where the electronic apparatus is within overage of the base station has been described above, and the data transmission mechanism in a case where the electronic apparatus is out of coverage of the base station will be described below.

As described above, in a case where the electronic apparatus is out of coverage of the base station, the electronic apparatus performs data transmission based on a pre-configured TFRP pool comprising the time-frequency resource blocks. That is, when the electronic apparatus is out of coverage of the base station, the TFRP time-frequency resource configured by the base station for the electronic apparatus is prohibited from being used, and the electronic apparatus uses a pre-configured TFRP pool to perform data transmission. As an example, the pre-configured TFRP of the electronic apparatus may be the factory configuration of the electronic apparatus. As once mentioned above, in a case where the electronic equipment is within coverage of the base station, in a case where there are relatively more electronic apparatuses within coverage of the base station so that the time-frequency resource is in shortage, the TFRP time-frequency resource configured by the base station for the electronic apparatus does not include shared resource blocks; and in a case where the time-frequency resource within coverage of the base station is relatively abundant, the TFRP time-frequency resource configured by the base station may include shared resource blocks. However, in a case where the electronic apparatus is out of coverage of the base station, the pre-configured TFRP of the electronic apparatus includes shared resource blocks.

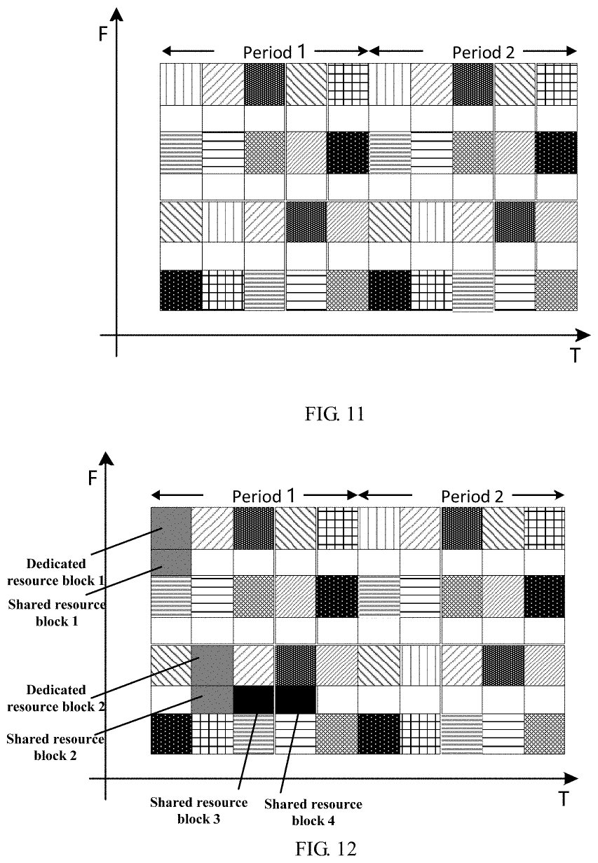

FIG. 11 shows a schematic diagram of a pre-configured TFRP pool according to an embodiment of the present disclosure. The structure of the pre-configured TFRP pool as shown in FIG. 11 is similar to the structure of the TFRP time-frequency resource as shown in FIG. 2, and will not be repeatedly described here.

Preferably, the processing unit 101 is configured to transfer data by using the shared resource blocks. In a case where the electronic apparatus is out of coverage of the base station, the UE does not know the usage conditions of time-frequency resources of other UEs. When the pre-configured time-frequency resource blocks of the UE cannot satisfy data transmission in cases such as resource conflicts and the like, the use of the shared resource blocks by the UE to transfer data can ensure fast and reliable data transmission.

Data packet sizes of different services are different, and even for the same service, data packet sizes at different times will also change. With regard to this problem, the UE can extend the dedicated resource blocks in frequency domain by the shared resource blocks, for adaptation to different data packet sizes. Preferably, the processing unit 101 is configured to simultaneously use the dedicated resource blocks and shared resource blocks adjacent to the dedicated resource blocks in frequency domain to jointly transfer data, so as to utilize the adjacent shared resource blocks to extend the dedicated resource blocks in frequency domain. FIG. 12 shows a schematic diagram of performing data transmission using shared resource blocks according to an embodiment of the present disclosure. As shown in FIG. 12, the UE uses TFRP time-frequency resource blocks to perform sending of data. For simplicity of description, it is assumed that a total of two TBs are sent, each TB being sent twice within one TFRP period. Assuming that a data packet of the first TB is relatively large, at the time of the first sending, the UE simultaneously uses, for example, a gray dedicated resource block 1 and a gray shared resource block 1 adjacent to the dedicated resource block 1 in frequency domain to jointly send the first TB; and at the time of the second sending, the UE simultaneously uses, for example, the gray dedicated resource block 2 and the gray shared resource block 2 adjacent to the dedicated resource block 2 in frequency domain to jointly send the first TB, thus utilizing the shared resource blocks adjacent to the dedicated resource blocks in frequency domain to extend the dedicated resource blocks in frequency domain.

Preferably, the processing unit 101 is configured to perform initial transmission and retransmission of data, by using shared resource blocks consecutive in time within one period of the TFRP time-frequency resource. As shown in FIG. 12, at the time of sending the second TB, the UE uses two consecutive shared resource blocks (for example, the two black shared resource blocks 3 and 4) within the period 1 of the TFRP time-frequency resource to perform initial transmission and retransmission so as to ensure fast sending and reception of the data.

Preferably, mini-slot transmission is a transmission manner in which the time-frequency resource block is divided in time into at least two mini-slot based resource blocks. In a case where the electronic apparatus out of coverage of the base station supports the mini-slot transmission, the processing unit 101 is configured to autonomously select the division granularity of the time-frequency resource block according to pre-configured information. As an example, in a case where the electronic apparatus out of coverage of the base station supports the mini-slot transmission, similar to a scenario where the electronic apparatus is within coverage area of the base station, the UE out of coverage of the base station may autonomously select the division granularity of the TFRP time-frequency resource block according to the PeriodScaler domain value in pre-configured information, depending on communication demands.

Preferably, the processing unit 101 is configured to reserve time-frequency resource blocks in the TFRP pool for data to be transmitted. As an example, if the time-frequency resource blocks pre-configured for the UE in the TFRP pool cannot satisfy transmission requirements, the UE may reserve other time-frequency resource blocks in the TFRP pool through SCI. With reference to FIG. 12 as an example, the UE may reserve other time-frequency resource blocks in the TFRP pool in SCI at the end of sending of the first TB. For example, the UE may reserve the time-frequency resource blocks in the TFRP pool which are used for sending the second TB.

In a case where the electronic apparatus is out of coverage of the base station, the electronic apparatus performs a sensing process and TFRP selection to determine appropriate TFRP time-frequency resource blocks to perform data transmission. Preferably, the processing unit 101 is configured to: exclude, from the TFRP pool, time-frequency resource blocks used by other users and time-frequency resource blocks reserved by the other users to obtain remaining time-frequency resource blocks; measure the level of interference suffered by the remaining time-frequency resource blocks, and sort the remaining time-frequency resource blocks based on a result of the measurement; select time-frequency resource blocks to transmit data, based on a sorting result, in combination with at least one of data priority and quality of service.

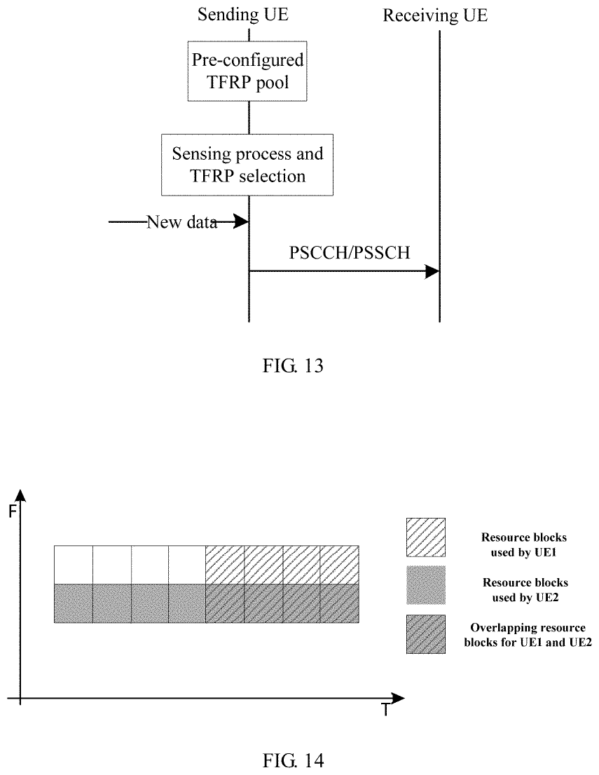

FIG. 13 shows information flow of performing data transmission between a UE (hereinafter referred to a sending UE) as a sending party and a UE (hereinafter referred to as a receiving UE) as a receiving party out of coverage of the base station in a submode 2c of V2X. As shown in FIG. 13, the sending UE shall perform data transmission based on a pre-configured TFRP pool; the sending UE continuously performs a sensing process, wherein the sensing process by the sending UE includes decoding for SCI and related measurements: the sending UE decodes the SCI to determine time-frequency resource blocks used by other users and time-frequency resource blocks reserved by the other users, so as to exclude the time-frequency resource blocks being used by the other users and the time-frequency resource blocks reserved by the other users, and the sending UE obtains the level (as examples, SL RSRP and SL RSSI) of interference suffered by remaining time-frequency resource blocks through measurement, and then sorts the remaining time-frequency resource blocks based on a result of the measurement; when new data arrives, the sending UE performs TFRP selection, that is, selects time-frequency resource blocks to transmit data, based on a sorting result, in combination with at least one of data priority and quality of service, thereby determining time-frequency resource blocks used by the sending UE for transmitting a PSCCH and a corresponding PS SCH.

Preferably, the processing unit 101 is configured to determine the repeat transmission number of data within one period of the TFRP time-frequency resource according to a channel state and the result of the measurement.

In a case where the electronic apparatus is out of coverage of the base station, when the electronic apparatus uses the time-frequency resource blocks in the pre-configured TFRP pool to send data, the processing unit 101 is configured to send SCI to an electronic apparatus as a receiving party, wherein the SCI at least includes information ExtensionIndicator indicating whether the dedicated resource blocks have been extended in frequency domain and information ReservationInfor indicating the reserved time-frequency resource blocks.

Furthermore, the above-mentioned SCI may also include the repeat transmission number repK within one period of the TFRP time-frequency resources, HARQ procedure ID (which indicates a HARQ procedure, for the electronic apparatus as the receiving party to perform soft combining), redundancy version number RV, information TFRP configuration concerning the used time-frequency resource blocks, and data priority PacketPrio.

In the submode 2c of V2X, the UE sends data based on TFRP resource blocks. The sending UE determines the repeat transmission number repK according to the sensing process and the related measurement results, so as to ensure the reliability of the data. In a Uu link, in Grant free sending mode, multiple retransmissions by the sending UE are not based on an HARQ feedback message of a receiving end, but are based on pre-configuration information of the base station. When the UE sends data, it will start a timer. When a set time does not arrive, the sending UE sends a specified redundancy version when the sending UE receives a new grant instruction for retransmissions from the base station; after a timeout of the timer, the sending UE defaults that the data is successfully received, and then refreshes the buffer to start new data sending. In SL, in the sub-mode 2c of V2X, the same feedback mechanism as the Uu link will cause resource collisions. FIG. 14 shows a schematic diagram of resource collisions. As shown in FIG. 14, UE1 and UE2 use overlapping resource blocks to perform sending of data, thereby resulting in resource collisions.

In addition, in the above-mentioned feedback mechanism, when the timing does not arrive, even if the receiving UE has successfully received the data, the sending UE will still repeatedly send the data several times until the pre-configured repeat transmission number is reached.

In a circumstance where the UE is out of coverage of the base station, different UEs use time-frequency resource blocks in the pre-configured TFRP pool, so it is inevitable that multiple UEs may select the same TFRP time-frequency resource block to perform sending of data; in a circumstance where the data has been successfully received, redundant repeat sending will result in resource collisions, and such collisions will continue for a long time; furthermore, since the timing does not arrive, the sending UE cannot refresh the buffer, and accordingly cannot perform sending of new data. In addition, in a circumstance where the UE is within coverage of the base station, in a circumstance where the data has been successfully received, since the timing does not arrive, the sending UE cannot refresh the buffer, and accordingly cannot perform sending of new data, because the timing does not arrive.

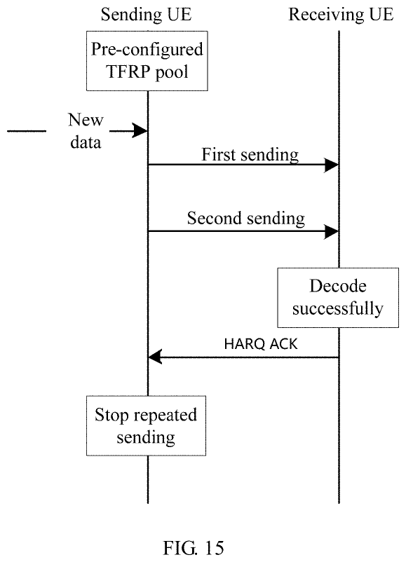

With regard to the above-mentioned problems, the present application proposes a new feedback mechanism. In a case where the electronic apparatus sends data, the processing unit 101 is configured to, with respect to each HARQ procedure: if a reception acknowledgement feedback is received from a receiving electronic apparatus as a receiving party, determine that the data is successfully received, and send new data. For simplicity of description, hereinafter, a UE as a sending party is referred to as a sending UE, and a UE as a receiving party is referred to as a receiving UE. As an example, if the sending UE receives a reception acknowledgement feedback ACK from the receiving UE, the sending UE deems that the data is successfully received, and then refreshes a buffer area to send new data. FIG. 15 shows exemplary information flow of performing HARQ feedback between the UE (hereinafter referred to as the sending UE) as the sending party and the UE (hereinafter referred to as the receiving UE) as the receiving party in the submode 2c of V2X. For simplicity of description, in FIG. 15, it is assumed that the sending UE is out of coverage of the base station. As shown in FIG. 15, the sending UE sends data based on the time-frequency resource blocks in the pre-configured TFRP pool; when new data arrives, the sending UE repeatedly sends new data to the receiving UE; if the receiving UE receives and successfully decodes the new data after the second sending, the receiving UE sends HARQ ACK to the sending UE; and after receiving the HARQ ACK, the sending UE stops repeated sending.

The processing unit 101 is configured to, with respect to each HARQ procedure: if no feedback is received from the receiving electronic apparatus, wait until sending timing ends, and then send new data.

Furthermore, the processing unit 101 is configured to, with respect to each HARQ procedure: if feedback information concerning time-frequency resource blocks for retransmitting the data is received from the receiving electronic apparatus after sending of the data reaches the repeat transmission number, select time-frequency resource blocks in combination with the feedback information to re-send the data.

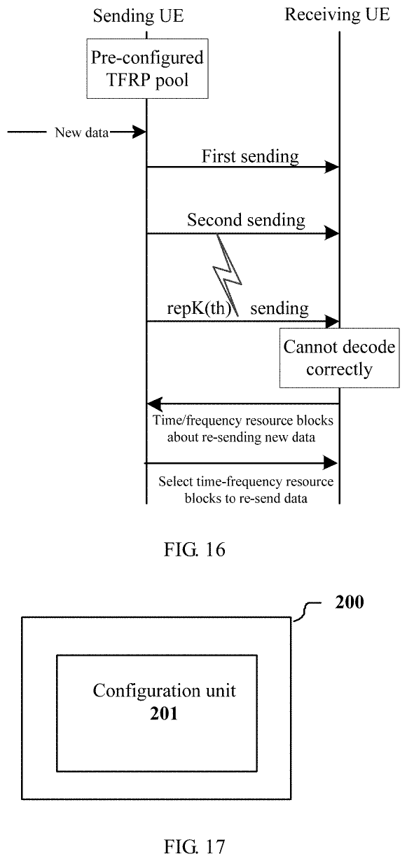

FIG. 16 shows another exemplary information flow of performing HARQ feedback between the UE (hereinafter referred to as the sending UE) as the sending party and the UE (hereinafter referred to as the receiving UE) as the receiving party in the submode 2c of V2X. For simplicity of description, in FIG. 16, it is assumed that the sending UE is out of coverage of the base station. As shown in FIG. 16, the sending UE sends data based on the time-frequency resource blocks in the pre-configured TFRP pool; when new data arrives, the sending UE repeatedly sends new data to the receiving UE; if the receiving UE cannot decode the new data correctly after sending of the new data by the sending UE reaches the repeat transmission number repK, the receiving UE sends feedback information concerning time-frequency resource blocks about re-sending the new data to the sending UE; and the sending UE selects time-frequency resource blocks in combination with the feedback information to re-send the data.

In addition, in a case where the electronic apparatus receives data, the processing unit 101 is configured to, with respect to each HARQ procedure: if the data has been successfully received, send a reception acknowledgement feedback to the sending electronic apparatus as the sending party. As an example, if the receiving UE successfully receives the data, a reception acknowledgement feedback ACK is sent in the PSFCH channel. If receiving the data from the sending electronic apparatus has not reached the repeat transmission number configured by the sending electronic apparatus and receiving shall still be continued, no information is fed back. If the data cannot be decoded after receiving the data from the sending electronic apparatus has reached the repeat transmission number, information indicating time-frequency resource blocks about retransmitting the data is sent to the sending electronic apparatus. As an example, if the receiving UE still cannot successfully decode the data when the transmission number of the data has reached the repeat transmission number repK, SFCI (Sidelink feedback control information) is sent to indicate a location of a time-frequency resource block in a better channel state, so as to schedule the sending UE to resend data on the new time-frequency resource block.

As can be known from the above description, the HARQ feedback mechanism according to the embodiments of the present disclosure can avoid resource collisions, and can refresh the buffer in time after data is successfully received, so that the sending UE performs sending of other data faster.

### Second Embodiment

FIG. 17 shows a block diagram of functional modules of an electronic apparatus 200 according to another embodiment of the present disclosure. As shown in FIG. 17, the electronic apparatus 200 comprises a configuration unit 201 configured to configure, for user equipment within coverage of the electronic apparatus 200, Time-Frequency Repetition Pattern TFRP time-frequency resources to perform data transmission, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

Wherein, the configuration unit 201 may be implemented by one or more processing circuitries which may be implemented as, for example, a chip.

The electronic apparatus 200 may be arranged on base station side or communicably connected to a base station, for example. It should also be noted herein that, the electronic apparatus 200 may be implemented at chip level or at device level. For example, the electronic apparatus 200 may work as a base station itself, and may also include external devices such as a memory, a transceiver (not shown in the figure) and the like. The memory may be used to store programs and related data information that the user equipment needs to execute in order to implement various functions. The transceiver may include one or more communication interfaces to support communication with different devices (e.g., a base station, other user equipment, etc.), and the implementation form of the transceiver is not specifically limited here.

Preferably, a frequency domain bandwidth of the shared resource block is equal to or less than that of the dedicated resource block. In the first embodiment, an example of the TFRP time-frequency resource has been described in detail in conjunction with FIG. 2, and will not be repeated here.

Preferably, each time-frequency resource block is divided in time into at least two mini-slot based resource blocks. Performing data transmission utilizing mini-slot-based resource blocks may reduce latency through faster retransmissions and can ensure the reliability of data by increasing the number of retransmissions. In the first embodiment, an example of dividing each time-frequency resource block into mini-slot-based resource blocks in time has been described in detail in conjunction with FIGS. 3(a) and 3(b), and will not be repeatedly described here.

The base station configures the TFRP time-frequency resources for the user equipment based on the information reported by the user equipment. Preferably, the configuration unit 201 is configured to receive, from the user equipment, at least reported information indicating whether the user equipment supports mini-slot transmission, for configuring resource blocks for the mini-slot transmission for the user equipment, wherein the time-frequency resource block is divided in time into at least two mini-slot based resource blocks in the mini-slot transmission. As an example, the reported information may also include: channel state information CSI, channel busy rate CBR, reference signal (DMRS/SRS), user's measurement results (SL RSRP and SL RSSI), and location information LocationInfor.

Preferably, the configuration unit 201 is configured to send radio resource control RRC signaling including information concerning the configured time-frequency resource blocks to the user equipment, wherein the RRC signaling is generated based on the reported information, and at least includes a frequency domain bandwidth BandWidthShared of the shared resource block and division granularity PeriodScaler of the time-frequency resource block. As an example, the RRC signaling may also include a period length PeriodLength of the TFRP time-frequency resource, the number NumberOfPeriod of periods of the TFRP time-frequency resource, the number NumberOfSymbolOfRep of symbols occupied by each time-frequency resource block, the data retransmission number NumberOfRepetition within one period, a start time StartTime of each time-frequency resource block, and a bandwidth BandWidthDedicate of a dedicated resource block.

In the first embodiment, an example of information flow of configuring TFRP time-frequency resources by a base station for a UE has been described in detail in conjunction with FIG. 4, and will not be repeated here.

Preferably, the configuration unit 201 is configured to dynamically update the time-frequency resource blocks configured for the user equipment, periodically and/or based on event triggering. In the first embodiment, an example of dynamically updating the time-frequency resource blocks configured for the user equipment, periodically and/or based on event triggering, has been described in detail in conjunction with FIG. 6 and FIG. 7, and will not be repeated here.

Preferably, the configuration unit 201 is configured to reconfigure, when receiving information concerning resources being preempted which is reported by the user equipment, the time-frequency resource blocks for the user equipment according to an application of the user equipment. In the first embodiment, an example of a preemption mechanism has been described in detail in conjunction with FIG. 9, and will not be repeated here.

Preferably, the configuration unit 201 is configured to reconfigure, when receiving information concerning failure of borrowing resources from user equipment as a receiving party or user equipment for sending with a lower priority than a priority of a service of the user equipment which is reported by the user equipment, the time-frequency resource blocks for the user equipment according to an application of the user equipment. In the first embodiment, an example of a borrowing mechanism has been described in detail in conjunction with FIG. 10, and will not be repeated here.

The above-mentioned electronic apparatus 200 may be used for wireless communications in V2X scenarios, D2D scenarios, MTC scenarios, drone scenarios, etc.

### Third Embodiment

In the process of describing the electronic apparatuses for wireless communications in the above implementations, some processing or methods obviously have also been disclosed. Hereinafter, an outline of these methods will be given without repeating some of the details that have been discussed above; however, it should be noted that, although these methods are disclosed in the process of describing electronic apparatuses for wireless communications, these methods do not necessarily employ those components as described or are not necessarily executed by those components. For example, the implementations of the electronic apparatuses for wireless communications may be partially or completely realized using hardware and/or firmware, while the methods for wireless communications discussed below may be completely implemented by a computer-executable program, although these methods may also employ hardware and/or firmware of the electronic apparatuses for wireless communications.

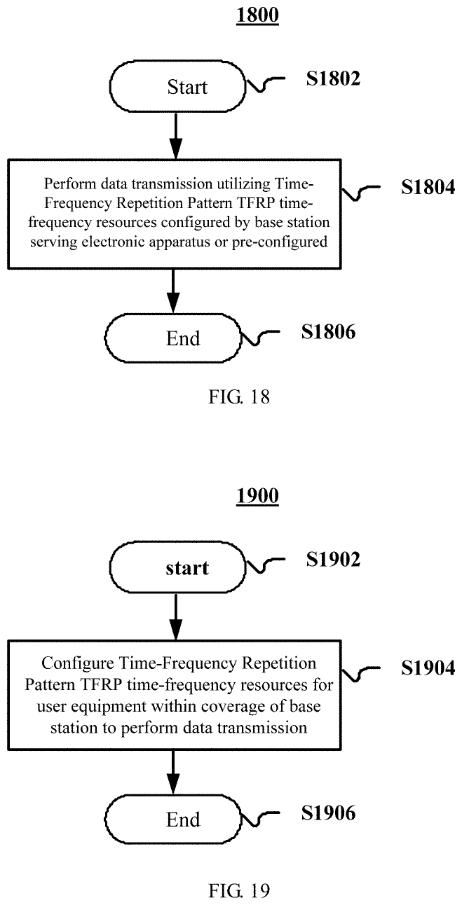

FIG. 18 shows a flowchart of a method 1800 for wireless communications according to an embodiment of the present application. The method 1800 starts in step S1802. In step S1804, data transmission is performed utilizing Time-Frequency Repetition Pattern TFRP time-frequency resources configured by a base station serving the electronic apparatus or pre-configured, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain. The method 1800 ends in step S1806. The method 1800 may be executed on the UE side.

The method may be executed by, for example, the electronic apparatus 100 as described in the first embodiment. Please refer to the description at the above corresponding position for specific details, which will not be repeated here.

FIG. 19 shows a flowchart of a method 1900 for wireless communications according to another embodiment of the present application. The method 1900 starts in step S1902. In step S1904, Time-Frequency Repetition Pattern TFRP time-frequency resources are configured for user equipment within coverage of a base station to perform data transmission, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain. The method 1900 ends in step S1906. The method 1900 may be executed on the base station side.

The method may be executed by, for example, the electronic apparatus 200 as described in the second embodiment. Please refer to the description at the above corresponding position for specific details, which will not be repeated here.

Note that, each of the above-mentioned methods may be used in combination or alone.

The technology of the present disclosure can be applied to various products.

For example, the electronic apparatus 200 may be implemented as various base stations. The base station may be implemented as any type of evolved Node B (eNB) or gNB (5G base station). An eNB includes, for example, macro eNBs and small eNBs. A small eNB may be an eNB that covers a cell smaller than a macro cell, such as a pico eNB, a micro eNB, and a home (femto) eNB. A similar situation can also apply to gNBs. Alternatively, the base station may be implemented as any other type of base station, such as a NodeB and a base transceiver station (BTS). The base station may include: a main body (also referred to as base station equipment) configured to control wireless communications; and one or more remote radio heads (RRHs) arranged at a different place from the main body. In addition, various types of user equipment can all operate as base stations by temporarily or semi-persistently performing base station functions.

The electronic apparatus 100 may be implemented as various user equipment. The user equipment may be implemented as a mobile terminal (such as a smart phone, a tablet personal computer (PC), a notebook PC, a portable game terminal, a portable/dongle type mobile router, and a digital camera) or a vehicle-mounted terminal (such as an automobile navigation device). The user equipment may also be implemented as a terminal (also referred to as a machine type communication (MTC) terminal) that executes Machine-to-Machine (M2M) communications. In addition, the user equipment may be a wireless communication module (such as an integrated circuit module including a single chip) installed on each of the above-mentioned terminals.

[Application Examples about Base Station]

### First Application Example

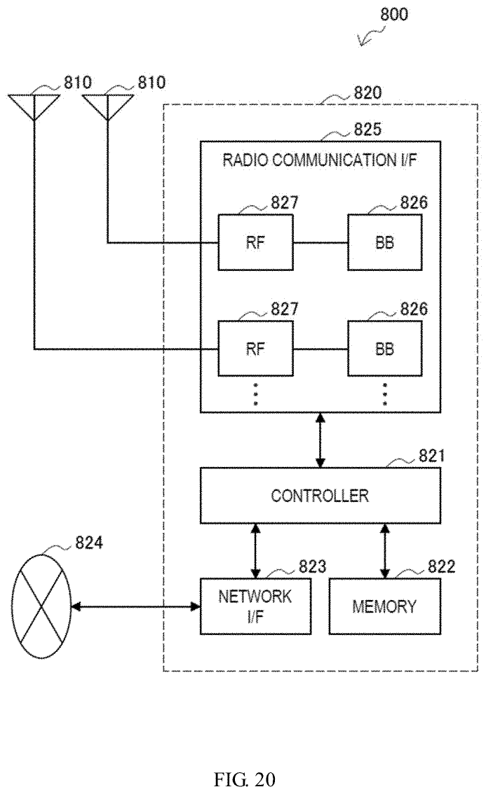

FIG. 20 is a block diagram showing a first example of a schematic configuration of an eNB or gNB to which the technology of the present disclosure can be applied. Note that, the following description takes an eNB as an example, but it may also be applied to a gNB. An eNB 800 includes one or more antennas 810 and base station equipment 820. The base station equipment 820 and each antenna 810 may be connected to each other via an RF cable.

Each of the antennas 810 includes a single or multiple antenna elements (such as multiple antenna elements included in a Multi-Input Multi-Output (MIMO) antenna), and is used for the base station equipment 820 to transmit and receive wireless signals. As shown in FIG. 20, the eNB 800 may include multiple antennas 810. For example, the multiple antennas 810 may be compatible with multiple frequency bands used by the eNB 800. Although FIG. 20 shows an example in which the eNB 800 includes multiple antennas 810, the eNB 800 may also include a single antenna 810.

The base station equipment 820 includes a controller 821, a memory 822, a network interface (I/F) 823, and a radio communication interface 825.

The controller 821 may be, for example, a CPU or a DSP, and manipulate various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have a logical function for performing control such as radio resource control, radio bearer control, mobility management, admission control, and scheduling. The control may be executed in conjunction with nearby eNBs or core network nodes. The memory 822 includes an RAM and an ROM, and stores programs executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or other eNBs may be connected to each other through a logical interface (such as an Si interface and an X2 interface). The network interface 823 may also be a wired communication interface, or a wireless communication interface for a wireless backhaul line. If the network interface 823 is a wireless communication interface, the network interface 823 may use a higher frequency band for wireless communications than the frequency band used by the radio communication interface 825.

The radio communication interface 825 supports any cellular communication scheme (such as Long Term Evolution (LTE) and LTE-Advanced), and provides wireless connection to a terminal located in a cell of the eNB 800 via an antenna 810. The radio communication interface 825 may generally include, for example, a baseband (BB) processor 826 and an RF circuit 827. The BB processor 826 may execute, for example, encoding/decoding, modulation/demodulation, and multiplexing/demultiplexing, and execute various types of signal processing of layers (e.g., L1, Medium Access Control (MAC), Radio Link Control (RLC), and Packet Data Convergence Protocol (PDCP)). Instead of the controller 821, the BB processor 826 may have a part or all of the above-mentioned logical functions. The BB processor 826 may be a memory storing a communication control program, or a module including a processor and related circuits configured to execute the program. An update program may cause the function of the BB processor 826 to be changed. The module may be a card or blade inserted into a slot of the base station equipment 820. Alternatively, the module may also be a chip mounted on a card or blade. Meanwhile, the RF circuit 827 may include, for example, a mixer, a filter, and an amplifier, and transmit and receive a wireless signal via the antenna 810.

As shown in FIG. 20, the radio communication interface 825 may include multiple BB processors 826. For example, the multiple BB processors 826 may be compatible with multiple frequency bands used by the eNB 800. As shown in FIG. 20, the radio communication interface 825 may include multiple RF circuits 827. For example, the multiple RF circuits 827 may be compatible with multiple antenna elements. Although FIG. 20 shows an example in which the radio communication interface 825 includes multiple BB processors 826 and multiple RF circuits 827, the radio communication interface 825 may also include a single BB processor 826 or a single RF circuit 827.

In the eNB 800 as shown in FIG. 20, the transceiver of the electronic apparatus 200 may be implemented by a radio communication interface 825. At least a part of the function may also be implemented by the controller 821. For example, the controller 821 may configure TFRP time-frequency resources for user equipment within coverage to perform data transmission, by executing the function of the configuration unit 201.

### Second Application Example

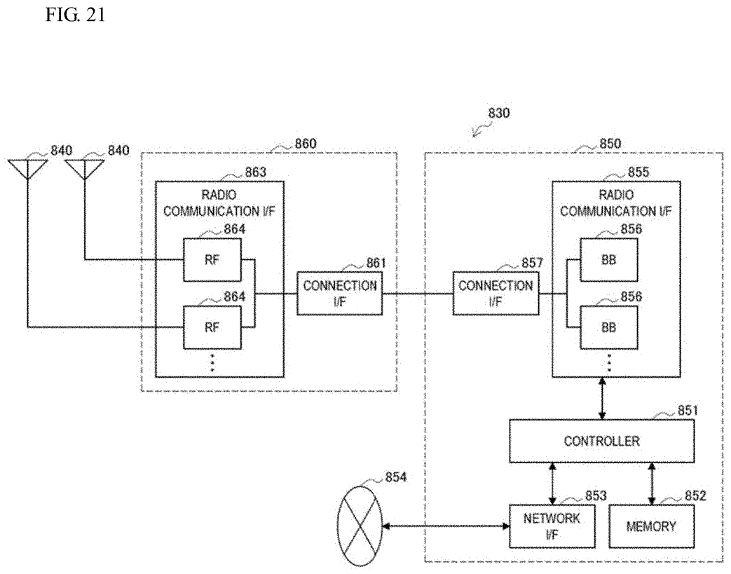

FIG. 21 is a block diagram showing a second example of a schematic configuration of an eNB or gNB to which the technology of the present disclosure can be applied. Note that similarly, the following description takes an eNB as an example, but it may also be applied to a gNB. An eNB 830 includes one or more antennas 840, base station equipment 850, and an RRH 860. The RRH 860 and each antenna 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna) and is used for the RRH 860 to transmit and receive a wireless signal. As shown in FIG. 21, the eNB 830 may include multiple antennas 840. For example, the multiple antennas 840 may be compatible with multiple frequency bands used by the eNB 830. Although FIG. 21 shows an example in which the eNB 830 includes multiple antennas 840, the eNB 830 may also include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 as described with reference to FIG. 20.

The radio communication interface 855 supports any cellular communication scheme (such as LTE and LTE-Advanced), and provides wireless communications to a terminal located in a sector corresponding to the RRH 860 via the RRH 860 and the antenna 840. The radio communication interface 855 may generally include, for example, a BB processor 856. The BB processor 856 is the same as the BB processor 826 as described with reference to FIG. 20 except that the BB processor 856 is connected to the RF circuit 864 of the RRH 860 via the connection interface 857. As shown in FIG. 21, the radio communication interface 855 may include multiple BB processors 856. For example, the multiple BB processors 856 may be compatible with multiple frequency bands used by the eNB 830. Although FIG. 21 shows an example in which the radio communication interface 855 includes multiple BB processors 856, the radio communication interface 855 may also include a single BB processor 856.

The connection interface 857 is an interface for connecting the base station equipment 850 (radio communication interface 855) to the RRH 860. The connection interface 857 may also be a communication module for communication in the above-mentioned high-speed line that connects the RRH 860 to the base station equipment 850 (radio communication interface 855).

The RRH 860 includes a connection interface 861 and a radio communication interface 863.

The connection interface 861 is an interface for connecting the RRH 860 (radio communication interface 863) to the base station equipment 850. The connection interface 861 may also be a communication module for communication in the above-mentioned high-speed line.

The radio communication interface 863 transfers and receives wireless signals via the antenna 840. The radio communication interface 863 may generally include, for example, an RF circuit 864. The RF circuit 864 may include, for example, a mixer, a filter, and an amplifier, and transfer and receive wireless signals via the antenna 840. As shown in FIG. 21, the radio communication interface 863 may include multiple RF circuits 864. For example, the multiple RF circuits 864 may support multiple antenna elements. Although FIG. 21 shows an example in which the radio communication interface 863 includes multiple RF circuits 864, the radio communication interface 863 may also include a single RF circuit 864.

In the eNB 830 as shown in FIG. 21, the transceiver of the electronic apparatus 200 may be implemented by the radio communication interface 825. At least a part of the function may also be implemented by the controller 821. For example, the controller 821 may configure TFRP time-frequency resources for user equipment within coverage to perform data transmission, by executing the function of the configuration unit 201.

[Application Example About User Equipment]

### First Application Example

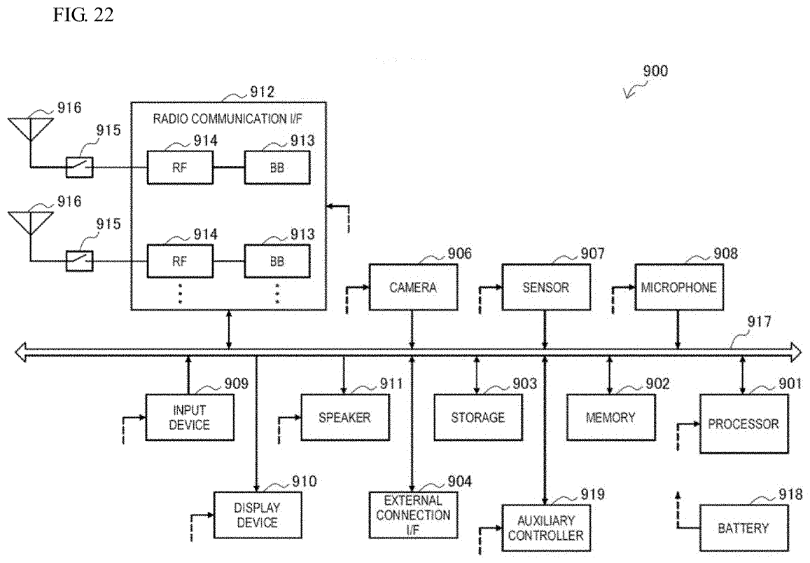

FIG. 22 is a block diagram showing an example of a schematic configuration of a smart phone to which the technology of the present disclosure can be applied. The smart phone 900 includes a processor 901, a memory 902, a storage 903, an external connection interface 904, an camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetic sensor, and an acceleration sensor. The microphone 908 converts sound input to the smart phone 900 into an audio signal. The input device 909 includes, for example, a touch sensor, a keypad, a keyboard, a button, or a switch configured to detect a touch on a screen of the display device 910, and receives an operation or information input from the user. The display device 910 includes a screen (such as a liquid crystal display (LCD) and an organic light emitting diode (OLED) display), and displays an output image of the smart phone 900. The speaker 911 converts the audio signal output from the smart phone 900 into sound.

The radio communication interface 912 supports any cellular communication scheme (such as LTE and LTE-Advanced), and executes wireless communications. The radio communication interface 912 may generally include, for example, a BB processor 913 and an RF circuit 914. The BB processor 913 may execute, for example, encoding/decoding, modulation/demodulation, and multiplexing/demultiplexing, and execute various types of signal processing for wireless communications. Meanwhile, the RF circuit 914 may include, for example, a mixer, a filter, and an amplifier, and transmit and receive wireless signals via the antenna 916. Note that, although the figure shows a circumstance where one RF link is connected with one antenna, this is only schematic, and a circumstance where one RF link is connected with multiple antennas through multiple phase shifters is also included. The radio communication interface 912 may be a chip module on which the BB processor 913 and the RF circuit 914 are integrated. As shown in FIG. 22, the radio communication interface 912 may include multiple BB processors 913 and multiple RF circuits 914. Although FIG. 22 shows an example in which the radio communication interface 912 includes multiple BB processors 913 and multiple RF circuits 914, the radio communication interface 912 may also include a single BB processor 913 or a single RF circuit 914.

Furthermore, in addition to the cellular communication scheme, the radio communication interface 912 may support other types of wireless communication schemes, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits included in the radio communication interface 912 (e.g., circuits for different wireless communication schemes).

Each of the antennas 916 includes a single or multiple antenna elements (such as multiple antenna elements included in a MIMO antenna), and is used for the radio communication interface 912 to transmit and receive wireless signals. As shown in FIG. 22, the smart phone 900 may include multiple antennas 916. Although FIG. 22 shows an example in which the smart phone 900 includes multiple antennas 916, the smart phone 900 may also include a single antenna 916.

Furthermore, the smart phone 900 may include an antenna 916 for each wireless communication scheme. In this case, the antenna switch 915 may be omitted from the configuration of the smart phone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to each block of the smart phone 900 as shown in FIG. 22 via a feeder line, which is partially shown as a dashed line in the figure. The auxiliary controller 919 manipulates the least necessary function of the smart phone 900 in a sleep mode, for example.

In the smart phone 900 as shown in FIG. 22, the transceiver of the electronic apparatus 100 may be implemented by the radio communication interface 912. At least a part of the function may also be implemented by the processor 901 or the auxiliary controller 919. For example, the processor 901 or the auxiliary controller 919 may perform data transmission utilizing TFRP time-frequency resources configured by the base station or pre-configured, by executing the function of the processing unit 101.

### Second Application Example

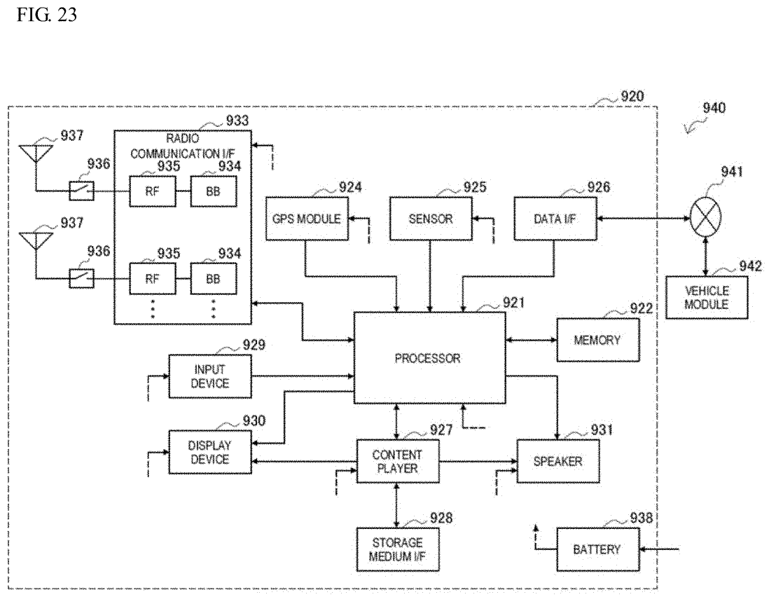

FIG. 23 is a block diagram showing an example of a schematic configuration of automobile navigation equipment to which the technology of the present disclosure can be applied. The automobile navigation equipment 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls the navigation function of the automobile navigation equipment 920 and additional functions. The memory 922 includes an RAM and an ROM, and stores data and programs executed by the processor 921.

The GPS module 924 uses a GPS signal received from a GPS satellite to measure a position of the automobile navigation equipment 920 (such as latitude, longitude, and altitude). The sensor 925 may include a group of sensors, such as a gyro sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD), which is inserted into the storage medium interface 928. The input device 929 includes, for example, a touch sensor, a button, or a switch configured to detect a touch on a screen of the display device 930, and receives an operation or information input from the user. The display device 930 includes a screen such as an LCD or OLED display, and displays an image of a navigation function or reproduced content. The speaker 931 outputs the sound of the navigation function or the reproduced content.

The radio communication interface 933 supports any cellular communication scheme, such as LTE and LTE-Advanced, and executes wireless communication. The radio communication interface 933 may generally include, for example, a BB processor 934 and an RF circuit 935. The BB processor 934 may execute, for example, encoding/decoding, modulation/demodulation, and multiplexing/demultiplexing, and execute various types of signal processing for wireless communications. Meanwhile, the RF circuit 935 may include, for example, a mixer, a filter, and an amplifier, and transmit and receive wireless signals via the antenna 937. The radio communication interface 933 may also be a chip module on which the BB processor 934 and the RF circuit 935 are integrated. As shown in FIG. 23, the radio communication interface 933 may include multiple BB processors 934 and multiple RF circuits 935. Although FIG. 23 shows an example in which the radio communication interface 933 includes multiple BB processors 934 and multiple circuits 935, the radio communication interface 933 may also include a single BB processor 934 or a single RF circuit 935.

Furthermore, in addition to the cellular communication scheme, the radio communication interface 933 may support types of wireless communication schemes, such as a short-range wireless communication scheme, a near field communication scheme, and a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits included in the radio communication interface 933 (e.g., circuits for different wireless communication schemes).

Each of the antennas 937 includes a single or multiple antenna elements (such as multiple antenna elements included in a MIMO antenna), and is used for the radio communication interface 933 to transmit and receive wireless signals. As shown in FIG. 23, the automobile navigation equipment 920 may include multiple antennas 937. Although FIG. 23 shows an example in which the automobile navigation equipment 920 includes multiple antennas 937, the automobile navigation equipment 920 may also include a single antenna 937.

Furthermore, the automobile navigation equipment 920 may include an antenna 937 for each wireless communication scheme. In this case, the antenna switch 936 may be omitted from the configuration of the automobile navigation equipment 920.

The battery 938 supplies power to each block of the automobile navigation equipment 920 as shown in FIG. 23 via a feeder line, which is partially shown as a dashed line in the figure. The battery 938 accumulates electric power supplied from the vehicle.

In the automobile navigation equipment 920 as shown in FIG. 23, the transceiver of the electronic apparatus 100 may be implemented by the radio communication interface 912. At least a part of the function may also be implemented by the processor 901 or the auxiliary controller 919. For example, the processor 901 or the auxiliary controller 919 may perform data transmission utilizing TFRP time-frequency resource configured by the base station or pre-configured, by executing the function of the processing unit 101.

The technology of the present disclosure may also be implemented as an in-vehicle system (or vehicle) 940 including one or more blocks in the automobile navigation equipment 920, the in-vehicle network 941, and the vehicle module 942. The vehicle module 942 generates vehicle data (such as vehicle speed, engine speed, and failure information), and outputs the generated data to the in-vehicle network 941.

The basic principle of the present invention has been described above in conjunction with specific embodiments. However, it should be pointed out that, for those skilled in the art, it could be understood that all or any step or component of the methods and devices of the present invention may be implemented in any computing device (including processors, storage media, etc.) or network of computing devices in the form of hardware, firmware, software, or a combination thereof. This can be achieved by those skilled in the art utilizing their basic circuit design knowledge or basic programming skills after reading the description of the present invention.

Moreover, the present invention also proposes a program product storing a machine-readable instruction code that, when read and executed by a machine, can execute the above-mentioned methods according to the embodiments of the present invention.

Accordingly, a storage medium for carrying the above-mentioned program product storing a machine-readable instruction code is also included in the disclosure of the present invention. The storage medium includes, but is not limited to, a floppy disk, an optical disk, a magneto-optical disk, a memory card, a memory stick, etc.

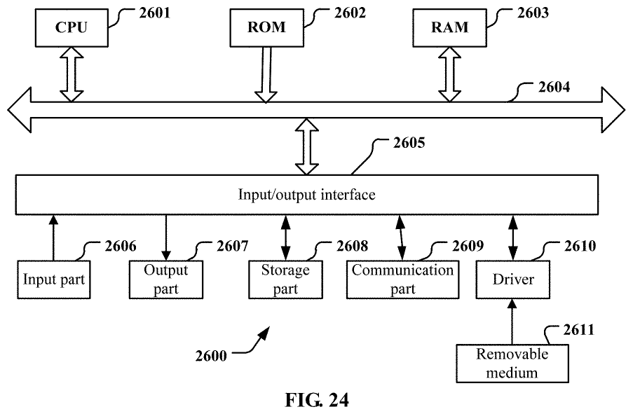

In a case where the present invention is implemented by software or firmware, a program constituting the software is installed from a storage medium or a network to a computer with a dedicated hardware structure (e.g., a general-purpose computer 2600 as shown in FIG. 24), and the computer, when installed with various programs, can execute various functions and the like.

In FIG. 24, a central processing unit (CPU) 2601 executes various processing in accordance with a program stored in a read only memory (ROM) 2602 or a program loaded from a storage part 2608 to a random access memory (RAM) 2603. In the RAM 2603, data required when the CPU 2601 executes various processing and the like is also stored as needed.

The CPU 2601, the ROM 2602, and the RAM 2603 are connected to each other via a bus 2604. The input/output interface 2605 is also connected to the bus 2604.

The following components are connected to the input/output interface 2605: an input part 2606 (including a keyboard, a mouse, etc.), an output part 2607 (including a display, such as a cathode ray tube (CRT), a liquid crystal display (LCD), etc., and a speaker, etc.), a storage part 2608 (including a hard disk, etc.), and a communication part 2609 (including a network interface card such as an LAN card, a modem, etc.). The communication part 2609 executes communication processing via a network such as the Internet. The driver 2610 may also be connected to the input/output interface 2605, as needed. A removable medium 2611 such as a magnetic disk, an optical disk, a magneto-optical disk, a semiconductor memory and the like is installed on the driver 2610 as needed, so that a computer program read out therefrom is installed into the storage part 2608 as needed.

In a case where the above-mentioned series of processing is implemented by software, a program constituting the software is installed from a network such as the Internet or a storage medium such as the removable medium 2611.

Those skilled in the art should understand that, this storage medium is not limited to the removable medium 2611 as shown in FIG. 24 which has a program stored therein and which is distributed separately from an apparatus to provide the program to users. Examples of the removable media 2611 include magnetic disks (including a floppy disk (registered trademark)), an optical disk (including a compact disk read-only memory (CD-ROM) and a digital versatile disk (DVD)), a magneto-optical disk (including a mini disk (MD) (registered trademark)), and a semiconductor memory. Alternatively, the storage medium may be the ROM 2602, a hard disk included in the storage part 2608, etc., which have programs stored therein and which are distributed concurrently with the apparatus including them to users.

It should also be pointed out that in the devices, methods and systems of the present invention, each component or each step may be decomposed and/or recombined. These decompositions and/or recombinations should be regarded as equivalent solutions of the present invention. Moreover, the steps of executing the above-mentioned series of processing may naturally be executed in chronological order in the order as described, but do not necessarily need to be executed in chronological order. Some steps may be executed in parallel or independently of each other.

Finally, it should be noted that, the terms “include”, “comprise” or any other variants thereof are intended to cover non-exclusive inclusion, so that a process, method, article or apparatus that includes a series of elements not only includes those elements, but also includes other elements that are not explicitly listed, or but also includes elements inherent to such a process, method, article, or apparatus. Furthermore, in the absence of more restrictions, an element defined by sentence “including one . . . ” does not exclude the existence of other identical elements in a process, method, article, or apparatus that includes the element.

Although the embodiments of the present invention have been described above in detail in conjunction with the accompanying drawings, it should be appreciated that, the above-described embodiments are only used to illustrate the present invention and do not constitute a limitation to the present invention. For those skilled in the art, various modifications and changes may be made to the above-mentioned embodiments without departing from the essence and scope of the present invention. Therefore, the scope of the present invention is defined only by the appended claims and equivalent meanings thereof

This technology can also be implemented as follows.

(1). An electronic apparatus for wireless communications, comprising:

processing circuitry configured to:

perform data transmission utilizing Time-Frequency Repetition Pattern TFRP time-frequency resources configured by a base station serving the electronic apparatus or pre-configured,

wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

(2). The electronic apparatus according to (1), wherein a frequency domain bandwidth of the shared resource block is equal to or less than that of the dedicated resource block.

(3). The electronic apparatus according to (1) or (2), wherein each time-frequency resource block is divided in time into at least two mini-slot based resource blocks.

(4). The electronic apparatus according to claim 1) or (2), wherein in a case where the electronic apparatus is within coverage of the base station, the time-frequency resource blocks are configured for the electronic apparatus by the base station.

(5). The electronic apparatus according to (4), wherein the processing circuitry is configured to:

receive, from the base station, information concerning configurations of the dedicated resource blocks of other electronic apparatuses within the coverage of the base station;

compare a priority of a service of the electronic apparatus with priorities of services of the other electronic apparatuses;

preempt the dedicated resource blocks of the electronic apparatus with a lower priority than the priority of the service of the electronic apparatus, for data transmission; and

send resource preemption information to the preempted electronic apparatuses

(6). The electronic apparatus according to (5), wherein the processing circuitry is configured to: send the resource preemption information through Sidelink Control Information, SCI, wherein the SCI comprises data priority, occupied resource duration, and information indicating occupied dedicated resource blocks.

(7). The electronic apparatus according to (5) or (6), wherein

if the preempted electronic apparatus is sending data through the preempted dedicated resource blocks when it is preempted, information concerning resources being preempted is reported to the base station and the base station is requested to reconfigure time-frequency resource blocks, and

if the preempted dedicated resource blocks are in an idle state when the preempted electronic apparatus is preempted, the information concerning resources being preempted is not reported to the base station in a case where the occupied resource duration is lower than a predetermined threshold, and the information concerning resources being preempted is reported to the base station in a case where the occupied resource duration is higher than the predetermined threshold.

(8). The electronic apparatus according to (4), wherein

the processing circuitry is configured to:

receive, from the base station, information concerning configurations of the dedicated resource blocks of other electronic apparatuses within the coverage of the base station;

send a resource borrowing application message to electronic apparatuses as receiving parties or electronic apparatuses for sending with lower priorities than the priority of the service of the electronic apparatus among the other electronic apparatuses;

if feedback information of consenting to borrowing is received from an electronic apparatus to which borrowing is applied for, select, from the dedicated resource blocks of the electronic apparatus to which borrowing is applied for, dedicated resource blocks to perform data transmission, and if no feedback information is received from the electronic apparatuses to which borrowing is applied for, apply to the base station for the time-frequency resource blocks for data transmission.

(9). The electronic apparatus according to (8), wherein the processing circuitry is configured to send the resource borrowing application message through Sidelink Control Information, SCI, wherein the SCI comprises data packet sending duration, data packet size, and data priority.

(10). The electronic apparatus according to (8) or (9), wherein the electronic apparatus to which borrowing is applied for, when receiving the resource borrowing application message, replies the feedback information of consenting to borrowing to the electronic apparatus if dedicated resource blocks of the electronic apparatus to which borrowing is applied for are in an idle state, and does not make a response if dedicated resource blocks of the electronic apparatus to which borrowing is applied for are not in an idle state.

(11). The electronic apparatus according to any one of (4) to (10), wherein

the processing circuitry is configured to report information to the base station, so that the base station configures the time-frequency resource blocks for the electronic apparatus based on the reported information, and

the reported information at least includes information indicating whether the electronic apparatus supports mini-slot transmission, wherein in the mini-slot transmission, the time-frequency resource block is divided in time into at least two mini-slot based resource blocks.

(12). The electronic apparatus according to (11), wherein

the processing circuitry is configured to receive, from the base station, radio resource control, RRC, signaling including information concerning the time-frequency resource block, wherein the RRC signaling is generated based on the information reported by the electronic apparatus, and at least includes a frequency domain bandwidth of the shared resource block and division granularity of the time-frequency resource block.

(13). The electronic apparatus according to (12), wherein

in a case where the electronic apparatus supports mini-slot transmission, the division granularity indicates the number of the mini-slot based resource blocks into which the time-frequency resource block is divided.

(14). The electronic apparatus according to any one of (4) to (13), wherein the configuration of the time-frequency resource blocks is dynamically updated by the base station periodically and/or based on event triggering.

(15). The electronic apparatus according to any one of (4) to (14), wherein

in a case where the electronic apparatus is configured with multiple sets of time-frequency resource blocks, the processing circuitry is configured to select a set of time-frequency resource blocks for data transmission based on at least one of data type, quality of service, communication manner and location information.

(16). The electronic apparatus according to any one of (4) to (15), wherein while satisfying the predetermined condition, the processing circuitry is configured to simultaneously use the dedicated resource blocks and shared resource blocks adjacent to the dedicated resource blocks in frequency domain to jointly transmit data, so as to utilize the adjacent shared resource blocks to extend the dedicated resource blocks in frequency domain.

(17). The electronic apparatus according to (1) or (2), wherein in a case where the electronic apparatus is out of coverage of the base station, the electronic apparatus performs data transmission based on a pre-configured TFRP pool comprising the time-frequency resource blocks.

(18). The electronic apparatus according to (17), wherein the processing circuitry is configured to transfer data by using the shared resource blocks.

(19). The electronic apparatus according to (18), wherein the processing circuitry is configured to simultaneously use the dedicated resource blocks and shared resource blocks adjacent to the dedicated resource blocks in frequency domain to jointly transfer data, so as to utilize the adjacent shared resource blocks to extend the dedicated resource blocks in frequency domain.

(20). The electronic apparatus according to (18), wherein the processing circuitry is configured to perform initial transmission and retransmission of data, by using shared resource blocks consecutive in time within one period of the TFRP time-frequency resources.

(21). The electronic apparatus according to any one of (17) to (20), wherein

mini-slot transmission is a transmission manner in which the time-frequency resource block is divided in time into at least two mini-slot based resource blocks,

in a case where the electronic apparatus supports the mini-slot transmission, the processing circuitry is configured to autonomously select division granularity of the time-frequency resource block according to pre-configured information.

(22). The electronic apparatus according to any one of (17) to (21), wherein the processing circuitry is configured to reserve time-frequency resource blocks in the TFRP pool for data to be transmitted.

(23). The electronic apparatus according to any one of (17) to (22), wherein

the processing circuitry is configured to
exclude, from the TFRP pool, time-frequency resource blocks used by other users and time-frequency resource blocks reserved by the other users to obtain remaining time-frequency resource blocks;
measure the level of interference suffered by the remaining time-frequency resource blocks, and sort the remaining time-frequency resource blocks based on a result of the measurement;
select time-frequency resource blocks to transmit data, based on a sorting result, in combination with at least one of data priority and quality of service.

(24). The electronic apparatus according to (23), wherein the processing circuitry is configured to determine the repeat transmission number of data within one period of the TFRP time-frequency resources according to a channel state and the result of the measurement.

(25). The electronic apparatus according to any one of (17) to (24), wherein the processing circuitry is configured to send Sidelink Control Information, SCI, to an electronic apparatus as a receiving party, wherein the SCI at least includes information indicating whether the dedicated resource blocks have been extended in frequency domain and information indicating the reserved time-frequency resource blocks.

(26). The electronic apparatus according to any one of (1) to (25), wherein

in a case where the electronic apparatus sends data, the processing circuitry is configured to, with respect to each Hybrid Automatic Repeat request, HARQ, procedure:
if a reception acknowledgement feedback is received from a receiving electronic apparatus as a receiving party, determine that the data is successfully received, and send new data,
if no feedback is received from the receiving electronic apparatus, wait until sending timing ends, and then send new data, and
if feedback information concerning time-frequency resource blocks for retransmitting the data is received from the receiving electronic apparatus after sending of the data reaches the repeat transmission number, select time-frequency resource blocks in combination with the feedback information to re-send the data.

(27). The electronic apparatus according to any one of (1) to (26), wherein

in a case where the electronic apparatus receives data, the processing circuitry is configured to, with respect to each Hybrid Automatic Repeat request, HARQ, procedure:
if the data has been successfully received, send a reception acknowledgement feedback to a sending electronic apparatus as a sending party,
if receiving the data from the sending electronic apparatus has not reached the repeat transmission number configured by the sending electronic apparatus and receiving shall still be continued, feed back no information, and
if the data cannot be decoded after receiving the data from the sending electronic apparatus has reached the repeat transmission number, send, to the sending electronic apparatus, information indicating time-frequency resource blocks about retransmitting the data.

(28). An electronic apparatus for wireless communications, comprising:

processing circuitry configured to:

configure, for user equipment within coverage of the electronic apparatus, Time-Frequency Repetition Pattern TFRP time-frequency resources to perform data transmission,

wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

(29). The electronic apparatus according to (28), wherein a frequency domain bandwidth of the shared resource block is equal to or less than that of the dedicated resource block.

(30). The electronic apparatus according to (28) or (29), wherein each time-frequency resource block is divided in time into at least two mini-slot based resource blocks.

(31). The electronic apparatus according to any one of (28) to (30), wherein the processing circuitry is configured to dynamically update the time-frequency resource blocks configured for the user equipment, periodically and/or based on event triggering.

(32). The electronic apparatus according to any one of (28) to (31), wherein the processing circuitry is configured to reconfigure, when receiving information concerning resources being preempted which is reported by the user equipment, the time-frequency resource blocks for the user equipment according to an application of the user equipment.

(33). The electronic apparatus according to any one of (28) to (31), wherein the processing circuitry is configured to reconfigure, when receiving information concerning failure of borrowing resources from user equipment as a receiving party or user equipment for sending with a lower priority than a priority of a service of the user equipment which is reported by the user equipment, the time-frequency resource blocks for the user equipment according to an application of the user equipment.

(34). The electronic apparatus according to any one of (28) to (33), wherein

the processing circuitry is configured to receive, from the user equipment, at least reported information indicating whether the user equipment supports mini-slot transmission, for configuring resource blocks for the mini-slot transmission for the user equipment, wherein the time-frequency resource block is divided in time into at least two mini-slot based resource blocks in the mini-slot transmission.

(35). The electronic apparatus according to (34), wherein the processing circuitry is configured to send radio resource control, RRC, signaling including information concerning the configured time-frequency resource blocks to the user equipment, wherein the RRC signaling is generated based on the reported information, and at least includes a frequency domain bandwidth of the shared resource block and division granularity of the time-frequency resource block.

(36). A method for wireless communications, comprising:

performing data transmission utilizing Time-Frequency Repetition Pattern TFRP time-frequency resources configured by a base station serving the electronic apparatus or pre-configured,

wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

(37). A method for wireless communications, comprising:

configuring, for user equipment within coverage of a base station, Time-Frequency

Repetition Pattern TFRP time-frequency resources to perform data transmission, wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

(38). A computer-readable storage medium having stored thereon computer-executable instructions that, when executed, execute the method for wireless communications according to either of (36) to (37).

1. An electronic apparatus for wireless communications, comprising:
processing circuitry configured to:
perform data transmission utilizing Time-Frequency Repetition Pattern, TFRP, time-frequency resources configured by a base station serving the electronic apparatus or pre-configured,
wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

2. The electronic apparatus according to claim 1, wherein a frequency domain bandwidth of the shared resource block is equal to or less than that of the dedicated resource block,
and/or
wherein each time-frequency resource block is divided in time into at least two mini-slot based resource blocks.

3. (canceled)

4. The electronic apparatus according to claim 1, wherein in a case where the electronic apparatus is within coverage of the base station, the time-frequency resource blocks are configured for the electronic apparatus by the base station.

5. The electronic apparatus according to claim 4, wherein
the processing circuitry is configured to:
receive, from the base station, information concerning configurations of the dedicated resource blocks of other electronic apparatuses within the coverage of the base station;
compare a priority of a service of the electronic apparatus with priorities of services of the other electronic apparatuses;
preempt the dedicated resource blocks of the electronic apparatus with a lower priority than the priority of the service of the electronic apparatus, for data transmission; and
send resource preemption information to the preempted electronic apparatuses.

6. The electronic apparatus according to claim 5, wherein the processing circuitry is configured to: send the resource preemption information through Sidelink Control Information, SCI, wherein the SCI comprises data priority, occupied resource duration, and information indicating occupied dedicated resource blocks, and/or
wherein if the preempted electronic apparatus is sending data through the preempted dedicated resource blocks when it is preempted, information concerning resources being preempted is reported to the base station and the base station is requested to reconfigure time-frequency resource blocks, and
if the preempted dedicated resource blocks are in an idle state when the preempted electronic apparatus is preempted, the information concerning resources being preempted is not reported to the base station in a case where the occupied resource duration is lower than a predetermined threshold, and the information concerning resources being preempted is reported to the base station in a case where the occupied resource duration is higher than the predetermined threshold.

7. (canceled)

8. The electronic apparatus according to claim 4, wherein
the processing circuitry is configured to:
receive, from the base station, information concerning configurations of the dedicated resource blocks of other electronic apparatuses within the coverage of the base station;
send a resource borrowing application message to electronic apparatuses as receiving parties or electronic apparatuses for sending with lower priorities than the priority of the service of the electronic apparatus among the other electronic apparatuses;
if feedback information of consenting to borrowing is received from an electronic apparatus to which borrowing is applied for, select, from the dedicated resource blocks of the electronic apparatus to which borrowing is applied for, dedicated resource blocks to perform data transmission, and if no feedback information is received from the electronic apparatuses to which borrowing is applied for, apply to the base station for the time-frequency resource blocks for data transmission.

9. The electronic apparatus according to claim 8, wherein the processing circuitry is configured to send the resource borrowing application message through Sidelink Control Information, SCI, wherein the SCI comprises data packet sending duration, data packet size, and data priority, and/or
wherein the electronic apparatus to which borrowing is applied for, when receiving the resource borrowing application message, replies the feedback information of consenting to borrowing to the electronic apparatus if dedicated resource blocks of the electronic apparatus to which borrowing is applied for are in an idle state, and does not make a response if dedicated resource blocks of the electronic apparatus to which borrowing is applied for are not in an idle state.

10. (canceled)

11. The electronic apparatus according to claim 3, wherein
the processing circuitry is configured to report information to the base station, so that the base station configures the time-frequency resource blocks for the electronic apparatus based on the reported information, and
the reported information at least includes information indicating whether the electronic apparatus supports mini-slot transmission, wherein in the mini-slot transmission, the time-frequency resource block is divided in time into at least two mini-slot based resource blocks.

12.-13. (canceled)

14. The electronic apparatus according to claim 3, wherein the configuration of the time-frequency resource blocks is dynamically updated by the base station periodically and/or based on event triggering, and/or
in a case where the electronic apparatus is configured with multiple sets of time-frequency resource blocks, the processing circuitry is configured to select a set of time-frequency resource blocks for data transmission based on at least one of data type, quality of service, communication manner and location information, and/or
wherein while satisfying the predetermined condition, the processing circuitry is configured to simultaneously use the dedicated resource blocks and shared resource blocks adjacent to the dedicated resource blocks in frequency domain to jointly transmit data, so as to utilize the adjacent shared resource blocks to extend the dedicated resource blocks in frequency domain.

15.-16. (canceled)

17. The electronic apparatus according to claim 1, wherein in a case where the electronic apparatus is out of coverage of the base station, the electronic apparatus performs data transmission based on a pre-configured TFRP pool comprising the time-frequency resource blocks.

18. The electronic apparatus according to claim 17, wherein the processing circuitry is configured to transfer data by using the shared resource blocks.

19. The electronic apparatus according to claim 18, wherein the processing circuitry is configured to simultaneously use the dedicated resource blocks and shared resource blocks adjacent to the dedicated resource blocks in frequency domain to jointly transfer data, so as to utilize the adjacent shared resource blocks to extend the dedicated resource blocks in frequency domain, or
wherein the processing circuitry is configured to perform initial transmission and retransmission of data, by using shared resource blocks consecutive in time within one period of the TFRP time-frequency resources.

20. (canceled)

21. The electronic apparatus according to claim 10, wherein
mini-slot transmission is a transmission manner in which the time-frequency resource block is divided in time into at least two mini-slot based resource blocks,
in a case where the electronic apparatus supports the mini-slot transmission, the processing circuitry is configured to autonomously select division granularity of the time-frequency resource block according to pre-configured information, and/or
wherein the processing circuitry is configured to reserve time-frequency resource blocks in the TFRP pool for data to be transmitted.

22. (canceled)

23. The electronic apparatus according to claim 10, wherein
the processing circuitry is configured to
exclude, from the TFRP pool, time-frequency resource blocks used by other users and time-frequency resource blocks reserved by the other users to obtain remaining time-frequency resource blocks;
measure the level of interference suffered by the remaining time-frequency resource blocks, and sort the remaining time-frequency resource blocks based on a result of the measurement;
select time-frequency resource blocks to transmit data, based on a sorting result, in combination with at least one of data priority and quality of service.

24. (canceled)

25. The electronic apparatus according to claim 10, wherein the processing circuitry is configured to send Sidelink Control Information, SCI, to an electronic apparatus as a receiving party, wherein the SCI at least includes information indicating whether the dedicated resource blocks have been extended in frequency domain and information indicating the reserved time-frequency resource blocks.

26. The electronic apparatus according to claim 1, wherein
in a case where the electronic apparatus sends data, the processing circuitry is configured to, with respect to each Hybrid Automatic Repeat request, HARQ, procedure:
if a reception acknowledgement feedback is received from a receiving electronic apparatus as a receiving party, determine that the data is successfully received, and send new data,
if no feedback is received from the receiving electronic apparatus, wait until sending timing ends, and then send new data, and
if feedback information concerning time-frequency resource blocks for retransmitting the data is received from the receiving electronic apparatus after sending of the data reaches the repeat transmission number, select time-frequency resource blocks in combination with the feedback information to re-send the data, and/or
wherein in a case where the electronic apparatus receives data, the processing circuitry is configured to, with respect to each Hybrid Automatic Repeat request, HAW), procedure:
if the data has been successfully received, send a reception acknowledgement feedback to a sending electronic apparatus as a sending party,
if receiving the data from the sending electronic apparatus has not reached the repeat transmission number configured by the sending electronic apparatus and receiving shall still be continued, feed back no information, and
if the data cannot be decoded after receiving the data from the sending electronic apparatus has reached the repeat transmission number, send, to the sending electronic apparatus, information indicating time-frequency resource blocks about retransmitting the data.

27. (canceled)

28. An electronic apparatus for wireless communications, comprising:
processing circuitry configured to:
configure, for user equipment within coverage of the electronic apparatus, Time-Frequency Repetition Pattern, TFRP, time-frequency resources to perform data transmission,
wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

29. The electronic apparatus according to claim 28, wherein a frequency domain bandwidth of the shared resource block is equal to or less than that of the dedicated resource block, and/or
each time-frequency resource block is divided in time into at least two mini-slot based resource blocks.

30. (canceled)

31. The electronic apparatus according to claim 17, wherein the processing circuitry is configured to dynamically update the time-frequency resource blocks configured for the user equipment, periodically and/or based on event triggering, and/or
wherein the processing circuitry is configured to reconfigure, when receiving information concerning resources being preempted which is reported by the user equipment, the time-frequency resource blocks for the user equipment according to an application of the user equipment, and/or
wherein the processing circuitry is configured to reconfigure, when receiving information concerning failure of borrowing resources from user equipment as a receiving party or user equipment for sending with a lower priority than a priority of a service of the user equipment which is reported by the user equipment, the time-frequency resource blocks for the user equipment according to an application of the user equipment, and/or
wherein the processing circuitry is configured to receive, from the user equipment, at least reported information indicating whether the user equipment supports mini-slot transmission, for configuring resource blocks for the mini-slot transmission for the user equipment, wherein the time-frequency resource block is divided in time into at least two mini-slot based resource blocks in the mini-slot transmission.

32.-35. (canceled)

36. A method for wireless communications, comprising:
performing data transmission utilizing Time-Frequency Repetition Pattern, TFRP, time-frequency resources configured by a base station serving the electronic apparatus or pre-configured,
wherein the TFRP time-frequency resource comprises a plurality of time-frequency resource blocks within one period, the plurality of time-frequency resource blocks comprises dedicated resource blocks and further comprises, while satisfying a predetermined condition, shared resource blocks, the dedicated resource blocks are used for performing transmission of data specific to the dedicated resource blocks, the shared resource blocks are shared by all data to be transmitted to perform transmission, and, different shared resource blocks having the same frequency domain range are consecutive in time domain.

37.-38. (canceled)
